(19) United States
(12) Patent Application Publication
(10) Pub. No.: US 2023/0303883 A1
(43) Pub. Date: Sep. 28, 2023

(54) SET OF LIQUID COMPOSITION, IMAGE FORMING METHOD, AND IMAGE FORMING APPARATUS

(71) Applicants: Toshiyuki KOBASHI, Tokyo (JP); Ayaka Tanaka, Kanagawa (JP)

(72) Inventors: Toshiyuki KOBASHI, Tokyo (JP); Ayaka Tanaka, Kanagawa (JP)

(73) Assignee: Ricoh Company, Ltd., Tokyo (JP)

(21) Appl. No.: 18/187,071

(22) Filed: Mar. 21, 2023

(30) Foreign Application Priority Data
Mar. 23, 2022 (JP) 2022-047265
Nov. 1, 2022 (JP) 2022-175549

(51) Int. Cl. C09D 11/54; C09D 11/322; D06P 5/30

(52) U.S. Cl. CPC C09D 11/54; C09D 11/322; D06P 5/30

(57) ABSTRACT

A set of liquid compositions contains a white ink, a first processing fluid containing an organic acid salt, and a second processing fluid containing a resin, wherein the first processing fluid is applied to fabric before the second processing fluid is applied thereto, and the second processing fluid is applied to the fabric before the white ink is applied thereto.

### CROSS-REFERENCE TO RELATED APPLICATIONS

This patent application is based on and claims priority pursuant to 35 U.S.C. § 119 to Japanese Patent Application Nos. 2022-047265 and 2022-175549, filed on Mar. 23, 2022, and Nov. 1, 2022, respectively, in the Japan Patent Office, the entire disclosures of which are hereby incorporated by reference herein.

### BACKGROUND

### Technical Field

The present disclosure relates to a set of liquid compositions, an image forming method, and an image forming apparatus.

### Description of the Related Art

Since inkjet printers can readily and quietly print color images with low running costs, they are now widely used at home to output digital information.

In the field of printing directly on a garment such as T-shirts, referred to as Direct to Garment (DTG), the demand for printing on polyester media for sportswear is rapidly increasing in addition to printing on conventional media like cotton and cotton/polyester blended media. This trend applies to the entire dyeing field as well as the DTG. For inkjet printers with an unwinding and winding mechanism, the demand for producing robust images with excellent coloring on many types of fabrics, including cotton and polyester, is increasing more and more.

### SUMMARY

According to embodiments of the present disclosure, a set of liquid compositions is provided which contains a white ink, a first processing fluid containing an organic acid salt, and a second processing fluid containing a resin, wherein the first processing fluid is applied to fabric before the second processing fluid is applied thereto, and the second processing fluid is applied to the fabric before the white ink is applied thereto.

As another aspect of embodiments of the present disclosure, an image forming method is provided which includes applying a first processing fluid containing an organic acid salt to fabric, applying a second processing fluid containing a resin to the region of the fabric where the first processing fluid has been applied, and applying a white ink to the region of the fabric where the second processing fluid has been applied.

As another aspect of embodiments of the present disclosure, an image forming apparatus is provided which includes a device for applying a first processing fluid containing an organic acid salt to fabric, a device for applying a second processing fluid containing a resin to the region of the fabric where the first processing fluid has been applied, and a device for applying a white ink to the region of the fabric where the second processing fluid has been applied.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1A is a schematic diagram illustrating an image forming apparatus according to an embodiment of the present invention;

FIG. 1B is a schematic diagram illustrating another image forming apparatus according to an embodiment of the present invention;

FIG. 2 is a schematic diagram illustrating an example of a controlling device of the image forming apparatus illustrated in FIG. 1A or FIG. 1B;

FIG. 3 is a flowchart illustrating an example of the operation of the image forming apparatus illustrated in FIG. 1A or FIG. 1B; and

FIG. 4 is a schematic diagram illustrating a cross-sectional view of the ink cartridge according to an embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a set of liquid composition is provided which can produce images striking a balance between concealing with white and robustness.

### Properties of Liquid Composition

The set of liquid composition of the present disclosure contains a white ink, a first processing fluid containing an organic acid salt, and a second processing fluid containing a resin, wherein the first processing fluid is applied to fabric before the second processing fluid is applied thereto, and the second processing fluid is applied to the fabric before the white ink is applied thereto.

In the set of liquid compositions of the present specification, the first processing fluid, the second processing fluid, and the white ink are independently present. The set of liquid compositions is not limited to the case of selling or manufacturing a container containing the first processing fluid, a container containing the second processing fluid, and a container containing the white ink in an integrated manner. The set includes the case where a container containing the first processing fluid, a container containing the second processing fluid, and a container containing the white ink are separately manufactured or sold while those inks are assumed or substantially guided to be used together, for example.

Printing on fabric, particularly fabric made of chemical fiber such as polyester dyed with a dark color dye, by an image forming method employing a known inkjetting method involves the transfer of the dye during thermal fixing of white ink when the white ink is used as an underlayer of color ink, thereby failing to achieve sufficient concealing with white and fastness.

Conversely, according to the set of liquid compositions of the present disclosure, the first processing fluid and the second processing fluid are applied in this sequence to fabric before the white ink is applied thereto. The carboxyl group in the organic acid salt in the first processing fluid and the resin in the second are allowed to conduct the cross-linking reaction. The resin thus agglomerates at the fiber's surface of the fabric, forming a resin film and staying on the surface. The dye in the fabric is prevented from transferring to the white ink after the white ink is applied and fixed by heating. Also, the white ink is prevented from permeating the fabric, so an image with excellent white concealing properties can be produced. Moreover, the resin film formed as a result of aggregation of the resin is firm and demonstrates excellent fastness.

### White Concealing Property

There is no specific limit to the white concealing properties. The white concealing is preferably 85 percent or greater, more preferably 88 percent or greater, and furthermore preferably 93 percent or greater. A white concealing of 85 percent or greater demonstrates excellent concealing with white to fabric.

The white concealing property of a white image formed on fabric with the white ink in the set of liquid compositions can be evaluated based on the white concealing property (percent) calculated according to the following relationship 1 of the optical density OD₁ of the fabric before a white ink image is formed and the optical density OD₂ of the fabric after the white ink image is formed.

The optical density OD of the white image can be measured with a spectrodensitometer, e.g., X-Rite eXact, manufactured by Videojet X-Rite K.K.

White concealing (percent)=(OD₁−OD₂)/OD₁×100 Relationship 1

### Fastness

The fastness of fabric on which an image is formed at the surface with the set of liquid compositions is not particularly limited and can be suitably selected to suit to a particular application. Preferably, the fabric demonstrates color fastness to washing and laundering.

The color fastness to washing and laundering can be evaluated according to the color fastness to washing and laundering test based on AATCC 61-2A. A level 3.5 or higher is preferable, a 4.0 or higher is more preferable, and a 4.5 or higher is furthermore preferable. AATCC 61-2A is a test developed by American Association of Textile Chemists and Colorists (Research Triangle Park, North Carolina, USA)

The set of liquid compositions of the present disclosure is described in detail below. It is to be noted that the following embodiments are not limiting the present disclosure and any deletion, addition, modification, change, etc. can be made within a scope in which man in the art can conceive including other embodiments, and any of which is included within the scope of the present disclosure as long as the effect and feature of the present disclosure are demonstrated.

### First Processing Fluid

The first processing fluid contains an organic acid salt and other optional components.

The first processing fluid aggregates the resin in the second processing fluid and the resin and pigment dispersion preferably contained in the white ink on the fabric. Specifically, the organic acid salt in the first processing fluid, the resin in the second, and the resin and the pigment dispersion preferably contained in the white ink are allowed to react, aggregating the resins and the pigment dispersion on the fabric. Due to this aggregation, the resins and the pigment can stay on the fabric's surface layer, forming an image with excellent white concealing properties.

### Organic Acid Salt

The organic acid salt in the first processing fluid is not particularly limited and can be suitably selected among known products to suit to a particular application. It is preferably an organic acid salt with a carboxyl group, including a water-soluble organic acid salt, such as an acetate, a lactate, a citrate, and a tartrate. These can be used alone or in combination.

Specific examples of the organic acid salt include, but are not limited to, sodium acetate, calcium acetate, sodium lactate, calcium lactate, ammonium lactate, and ammonium lactate.

Of these, either or both calcium acetate and calcium lactate are preferable to achieve good solubility, white concealing property, and fastness.

The proportion of the organic acid salt in the first processing fluid is not particularly limited and can be suitably selected to suit to a particular application. The lower limit is preferably 1 percent by mass or greater, more preferably 3 percent by mass or greater, and furthermore preferably 6 percent by mass or greater to the entire mass of the first processing fluid in terms of white concealing property. The upper limit is not particularly limited and can be suitably selected to suit to a particular application. It is preferably 20 percent by mass or less and more preferably 10 percent by mass or less to the entire mass of the first processing fluid in terms of solubility. The upper limit and the lower limit can be suitably combined. It is preferably from 3 to 20 percent by mass, more preferably from 3 to 10 percent by mass, and more preferably from 6 to 10 percent by mass.

### Other Optional Components

The other optional components in the first processing fluid are not particularly limited and they can be suitably selected to suit to a particular application. Examples thereof are an organic solvent, water, a surfactant, a defoaming agent, a pH regulator, a preservatives and fungicides, and a corrosion inhibitor. These can be used alone or in combination.

### Organic Solvent

The organic solvent is not particularly limited. It can be a water-soluble organic solvent, such as polyols, ethers such as polyol alkylethers and polyol arylethers, nitrogen-containing heterocyclic compounds, amides, amines, and sulfur-containing compounds. These can be used alone or in combination.

Specific examples of the water-soluble organic solvent include, but are not limited to: polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, petriol, and 3-methoxy-3-methyl-1-butanol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3 -dimethyl-2-imidazolidinone, ϵ-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

Of the organic solvents, an organic solvent with a boiling point of 250 degrees C. or lower is preferable to impart a good drying property in addition to the function as humectant.

Polyol compounds having eight or more carbon atoms and glycol ether compounds are also suitable as the organic solvents.

Specific examples of the polyol compounds having eight or more carbon atoms include, but are not limited to, 2-ethyl-1,3-hexanediol and 2,2,4-trimethyl-1,3-pentanediol.

Specific examples of the glycolether compound include, but are not limited to, polyhydric alcohol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether and polyhydric alcohol arylethers such as ethylene glycol monophenylether and ethylene glycol monobenzylether.

The content of the organic solvent in the first processing fluid is not particularly limited and can be suitably selected to suit to a particular application such as the method of applying the first processing fluid. The first processing fluid may not contain the organic solvent mentioned above when the first processing fluid is applied by spray coating. If the first processing fluid is applied by inkjetting, the first processing fluid preferably contains the organic solvent mentioned above to retain the moisture of a head and match the dischargeable viscosity range.

The proportion of the organic solvent in the first processing fluid is not particularly limited and it can be suitably selected to suit to a particular application. It is preferably from 10 to 60 percent by mass and more preferably from 20 to 60 percent by mass to the entire mass of the first processing fluid.

### Water

There is no specific limitation to water in the first processing fluid and it can be suitably selected to suit to a particular application. For example, pure water such as deionized water, ultrafiltered water, reverse osmosis water, and distilled water, and ultra pure water are suitable. These can be used alone or in combination.

The proportion of water in the first processing fluid is not particularly limited and can be suitably selected to suit a particular application. It is preferably from 10 to 90 percent by mass and more preferably from 20 to 60 percent by mass to the entire mass of the first processing fluid to quickly dry and reliably discharge the first processing fluid.

### Surfactant

Silicone-based surfactants, fluorochemical surfactants, amphoteric surfactants, nonionic surfactants, and anionic surfactants can be used as the surfactant. These can be used alone or in combination.

### Silicone-Based Surfactant

The silicone-based surfactant is not particularly limited and it can be suitably selected to suit to a particular application. Preferably, the silicone-based surfactant is not decomposed even in a high pH environment.

Specific examples include, but are not limited to, side-chain-modified polydimethylsiloxane, both end-modified polydimethylsiloxane, one end modified polydimethylsiloxane, and side-chain both end modified polydimethylsiloxane. A polyether-modified silicone-containing surfactant with a polyoxyethylene or polyoxyethylene polyoxypropylene group is particularly preferable to act sufficiently good as an aqueous surfactant.

A polyether-modified silicone-based surfactant can be used as the silicone-based surfactant. One of the surfactants is a compound in which a polyalkylene oxide structure is introduced into the side chain of the Si site of dimethyl silooxane.

The silicone-based surfactant can be synthesized or procured.

Products of the silicone-based surfactant can be procured from manufacturers, such as BYK-Chemie GmbH, Shin-Etsu Silicone Co., Ltd., Dow Corning Toray Co., Ltd., NIHON EMULSION Co., Ltd., and Kyoeisha Chemical Co., Ltd.

The polyether-modified silicon-based surfactant is not particularly limited and it can be suitably selected to suit to a particular application. One of the surfactants is a compound in which the polyalkylene oxide structure represented by the following Chemical Formula S-1 is introduced into the side chain of the Si site of dimethyl polysiloxane.

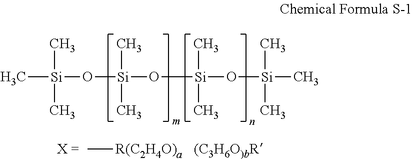

In Chemical Formula S-1, m, n, a, and b each, respectively represent integers, R represents an alkylene group, and R′ represents an alkyl group.

Polyether-modified silicone-containing surfactant can be synthesized or procured.

Specific examples of the products of the polyether-modified silicone-based surfactant include, but are not limited to, KF-618, KF-642, and KF-643 (all manufactured by Shin-Etsu Chemical Co., Ltd.), EMALEX SS-5602 and EMALEX SS-1906EX (both manufactured by NIHON EMULSION Co., Ltd.), DOWSIL FZ-2105, DOWSIL FZ-2118, DOWSIL FZ-2154, DOWSIL FZ-2161, DOWSIL FZ-2162, DOWSIL FZ-2163, and DOWSIL FZ-2164 (all manufactured by Dow Corning Toray Co., Ltd.), BYK-33 and BYK-387 (both manufactured by BYK Chemie GmbH), and TSF4440, TSF4452, and TSF4453 (all manufactured by Toshiba Silicone Co. Ltd.).

### Fluorochemical Surfactant

The fluorochemical surfactant mentioned above is not particularly limited and it can be suitably selected to suit to a particular application.

It is preferably a fluorine-substituted compound with 2 to 16 carbon atoms and more preferably fluorine-substituted compound with 4 to 16 carbon atoms.

Specific examples include, but are not limited to, a perfluoroalkyl phosphoric acid ester compound, an adduct of perfluoroalkyl with ethylene oxide, and polyoxyalkylene ether polymer compound with a perfluoroalkyl ether group in its side chain because of their low foaming property. These can be used alone or in combination.

Specific examples of the perfluoroalkyl sulfonic acid compound include, but are not limited to, perfluoroalkyl sulfonic acid and salts of perfluoroalkyl sulfonic acid.

Specific examples of the perfluoroalkyl carbonic acid compound include, but are not limited to, perfluoroalkyl carbonic acid and salts of perfluoroalkyl carbonic acid.

Specific examples of the polyoxyalkylene ether polymer compound having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain.

Counter ions of salts in these fluorine-containing surfactants are, for example, Li, Na, K, NH₄, NH₃CH₂CH₂OH, NH₂(CH₂CH₂OH)₂, and NH(CH₂CH₂OH)₃.

Of these, polyoxyalkylene ether polymer compounds having a perfluoroalkyl ether group in its side chain are preferable because these do not readily foam and the fluorochemical surfactant represented by the following Chemical Formula F-1 or Chemical Formula F-2 is preferable.

CF₃CF₂(CF₂CF₂)ₘ—CH₂CH₂O (CH₂CH₂O)ₙH Chemical Formula F-1

In the compound represented by Chemical Formula F-1, “m” is preferably 0 or an integer of from 1 to 10 and “n” is preferably 0 or an integer of from 1 to 40.

CnF₂ₙ₊₁—CH₂CH(OH)CH₂—O—(CH₂CH₂O)ₐ—Y Chemical Formula F-2

In the compound represented by Chemical Formula F-2, Y represent hydrogen, CₘF₂ₘ₊₁, where m represents an integer of from 1 to 6, CH₂CH(OH)CH₂—C_{q}F_{2q+1}, where q represents an integer of from 4 to 6, or C_{P}H_{2P+1}, where p is an integer of from 1 to 19, n represents an integer of from 1 to 6, and a represents an integer of from 4 to 14.

The fluorochemical surfactant can be synthesized and procured.

Specific examples of the products of the fluorochemical surfactants include, but are not limited to, SURFLON® 5-111, 5-112, 5-113, 5-121, 5-131, 5-132, 5-141, and 5-145 (all manufactured by AGC SEIMI CHEMICAL CO., LTD.), FLUORAD FC-93, FC-95, FC-98, FC-129, FC-135, FC-170C, FC-430, and FC-431 (all manufactured by Sumitomo 3M Limited); MEGAFACE F-470, F-1405, and F-474 (all manufactured by DIC CORPORATION), ZONYL° TBS, FSP, FSA, FSN-100, FSN, FSO-100, FSO, and FS-300 UR, Capstone® FS-30, FS-31, FS-3100, FS-34, and FS-35 (all manufactured by E. I. du Pont de Nemours and

Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.), and UNIDYNE DSN-403N (manufactured by DAIKIN INDUSTRIES). Of these, Zonyl° FS-3100, FS-34, and FS-300 (manufactured by The Chemours Company), FT-110, FT-250, FT-251, FT-400S, FT-150, and FT-400SW (manufactured by NEOS COMPANY LIMITED), PolyFox PF-151N (manufactured by OMNOVA SOLUTIONS INC.), and UNIDYNE DSN-403N (manufactured by DAIKIN INDUSTRIES) are particularly preferable to achieve good printing quality and significantly enhance coloring.

### Surfactant

The amphoteric surfactant is not particularly limited and can be suitably selected to suit to a particular application.

Specific examples include, but are not limited to, lauryl aminopropionic acid salts, lauryl dimethyl betaine, stearyl dimethyl betaine, and lauryl dihydroxyethyl betaine. These can be used alone or in combination.

### Nonionic Surfactant

The nonionic surfactant is not particularly limited and it can be suitably selected to suit to a particular application.

Specific examples include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides. These can be used alone or in combination.

### Anionic Surfactant

The anionic surfactant is not particularly limited and can be suitably selected to suit to a particular application.

Specific examples include, but are not limited to, salts such as a polyoxyethylene alkylether acetate, a dodecylbenzene sulfonate, a laurate, and a polyoxyethylene alkylether sulfate. These can be used alone or in combination.

The content of the surfactant in the first processing fluid is not particularly limited and can be suitably selected to suit to a particular application, such as the method of applying the first processing fluid. The first processing fluid may not contain the surfactant mentioned above when the first processing fluid is applied by spray coating. If the first processing fluid is applied by inkjetting, the first processing fluid preferably contains the surfactant mentioned above to in terms of moisture retaining at a head and matching to the dischargeable viscosity range

The proportion of the surfactant in the first processing fluid is not particularly limited and it can be suitably selected to suit to a particular application. It is preferably from 0.001 to 5 percent by mass and more preferably from 0.05 to 5 percent by mass to the entire mass of the first processing fluid.

### Defoaming Agent

The defoaming agent is not particularly limited. Examples include, but are not limited to silicon-based defoaming agents, polyether-based defoaming agents, and aliphatic acid ester-based defoaming agents. These can be used alone or in combination. Of these, silicone-based defoaming agents are preferable to enhance the ability of braking foams.

### pH Regulator

The pH regulator is not particularly limited as long as it can control the pH to 7 or greater. It includes, but is not limited to, amines such as diethanol amine and triethanol amine. These can be used alone or in combination.

### Preservatives and Fungicides

The preservatives and fungicides are not particularly limited. One specific example is 1,2-benzisothiazoline-3-one.

### Corrosion Inhibitor

The corrosion inhibitor is not particularly limited.

Specific examples include, but are not limited to, acid sulfites and sodium thiosulfates. These can be used alone or in combination.

The organic acid salt and the other optional components contained in the first processing fluid can be qualitatively and quantitatively analyzed by a Gas Chromatography Mass Spectrometry (GC-MS), for example. One of the measuring devices of GC-MS is GCMS-QP 2020NX, manufactured by Shimadzu Corporation. For each functional group in each component in the first processing fluid, which functional group modifies a substance can be determined by confirming the peak detected by the measuring method mentioned above.

The moisture in the first processing fluid can be typically measured by an available method, such as quantitative analysis of the volatile components by GC-MS or mass variation by thermogravimeter-differential thermal analysis (TG-DTA).

### Property of First Processing Fluid

Properties of the first processing fluid are not particularly limited and they can be suitably selected to suit to a particular application. The first processing fluid preferably has properties such as viscosity, surface tension, and pH in the following ranges.

### Viscosity of First Processing Fluid

The first processing fluid preferably has a viscosity of from 5 to 30 mPa·s and more preferably from 5 to 25 mPa·s at 25 degrees C. to achieve good dischargeability and readily form a film on fabric by inkjetting.

Viscosity can be measured with equipment such as a rotatory viscometer, RE-80L, manufactured by TOKI SANGYO CO., LTD. The measuring conditions are as follows:
Standard cone rotor (1°34′×R24)
Sample liquid amount: 1.2 mL
Rate of rotation: 50 rotations per minute (rpm)
25 degrees C.
Measuring time: three minutes.

### Surface Tension of First Processing Fluid

The surface tension of the first processing fluid is preferably 35 mN/m or less and more preferably 32 mN/m or less at 25 degrees C. because the first processing fluid suitably levels on fabric and the first processing fluid dries quickly.

### First Processing Fluid

The pH of the first processing fluid is preferably from 7 to 12 and more preferably from 8 to 11 to prevent metal materials in contact with the first processing fluid from corroding.

### Second Processing Fluid

The second processing fluid contains a resin and other optional components.

### Resin

The resin in the second processing fluid is not particularly limited and can be suitably selected to suit to a particular application. It includes, but is not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins. These can be used alone or in combination.

Of these, urethane resins, polyester resins, acrylic-based resins, styrene-based resins, acrylic styrene-based resins, and acrylonitrile-styrene resins are preferable, and urethane resins, acrylic-based resins, and acrylic-styrene resins are more preferable to achieve good fastness.

The resin preferably contains a resin with an oxazoline group (hereinafter also referred to as an oxazoline group-containing resin). The oxazoline group in the second processing fluid is allowed to react with the carboxyl group in the organic acid salt in the first processing fluid, forming a firm film with a cross-linking structure of amide ester bonding, which is preferable to achieve excellent fastness. In addition, if the resin in the white ink mentioned above has a carboxyl group, the oxazoline group in the oxazoline group-containing resin is also allowed to react with the carboxyl group, making the firm film stronger with a cross-linking structure of amide ester bonding, which is preferable to further achieve excellent fastness.

The resin particle can be synthesized or procured.

Specific examples of the products of the resin include, but are not limited to, EPOCROS® K-2000 series (oxazoline group-containing acrylic-stylene-based resin), EPOCROS® WS series (oxazoline group-containing acrylic-based resin), EPOCROS® RPS series (oxazoline group-containing stylene-based resin), and EPOCROS® RAS series (oxazoline group-containing acrylonitrile-stylene-based resin).

The resin mentioned above can be used in a form of particles and fine particles with the resin adsorbed to their surface can be used.

The fine particles with the resin adsorbed to their surface can be synthesized or procured.

Specific examples of the products of the fine particles with the resin adsorbed to their surface include, but are not limited to, organic fine particles of ME series, manufactured by Sohken Chemical Corporation, JURYMER® MB series, manufactured by TOAGOSEI CO., LTD., TOSPEARL series, manufactured by Momentive Performance Materials Inc., “Microgel series”, manufactured by NIPPONPAINT Co., Ltd., and Fluon®, manufactured by AGC Inc., and inorganic fine particles of Titania series, manufactured by Idemitsu Kosan Co., Ltd., and Aluminum oxide C, manufactured by Nippon Aerosil Co., Ltd.

The second processing fluid can be obtained by mixing a resin emulsion in which those resin particles are dispersed in water as a dispersion medium with the other optional components.

The volume average particle diameter (mean volume diameter) of the resin particle is not particularly limited and can be suitably selected to suit to a particular application. The mean volume diameter is preferably from 10 to 1,000 nm, more preferably from 10 to 200 nm, and particularly preferably from 10 to 100 nm to achieve a good fixability and image hardness.

The volume average particle diameter can be measured by using a device such as a particle size analyzer (Nanotrac Wave-UT151, manufactured by MicrotracBEL Corp.).

The weight average particle diameter Mw of the resin is not particularly limited and it can be suitably selected to suit to a particular application. It is preferably from 10,000 to 200,000. A weight average molecular weight Mw of 10,000 or greater is preferable to achieve good fastness. A weight average molecular weight Mw of 200,000 or less is preferable to stabilize discharging.

One way of obtaining the weight average molecular weight Mw of the resin particle is to obtain polystyrene conversion molecular weight measured by gel permeation chromatography (GPC) using tetrahydrofuran as solvent.

The glass transition temperature Tg of the resin is not particularly limited and it can be suitably selected to suit to a particular application. It is preferably 50 degrees C. or lower, more preferably 0 degrees C. or lower, and more preferably lower than 0 degrees C. A Tg of 50 degrees C. or lower leads to good fastness. A Tg of lower than 0 degrees C. enhances the filming property of the resin and achieves sufficient flexibility, enhancing substrate attachability, which is more preferable. The Tg of the resin is preferably −80 degrees C. or higher to stabilize an emulsion.

The proportion of the resin in the second processing fluid is not particularly limited and it can be suitably selected to suit to a particular application. The lower limit of the proportion is preferably 1 percent by mass or greater, more preferable 3 percent by mass or greater, and furthermore preferably 5 percent by mass or greater to the entire mass of the second processing fluid to retain the aggregated matter of the organic acid salt in the first processing fluid on the fiber's surface of fabric, thereby making the white ink stay on the fabric's surface. A high level of white concealing is thus obtained. The upper limit is not particularly limited and can be suitably selected to suit to a particular application. It is preferably 10 percent by mass or less and more preferably 10 percent by mass or less to the entire mass of the second processing fluid to keep the texture of fabric. The upper limit and the lower limit can be suitably combined. It is preferably from 1 to 10 percent by mass, more preferably from 3 to 10 percent by mass, and more preferably from 5 to 10 percent by mass.

Moreover, white concealing and fastness become excellent when the proportion of the organic acid salt in the first processing fluid is from 6 to 10 percent by mass and the proportion of the resin in the second processing fluid is from 3 to 10 percent by mass.

### Other Optional Components

The other optional components in the second processing fluid are not particularly limited and they can be suitably selected to suit to a particular application. Examples thereof include, but are not limited to, an organic solvent, water, a surfactant, a defoaming agent, a pH regulator, a preservatives and fungicides, and a corrosion inhibitor. These can be used alone or in combination.

Since the other optional components in the second processing fluid can be used in the same manner as those in the first processing fluid, their description is omitted. However, the proportions of the organic solvent and the surfactant mentioned above in the second processing fluid are preferably in the following ranges.

### Organic Solvent

The proportion of the organic solvent in the second processing fluid is not particularly limited and can be suitably selected to suit a particular application. It is preferably from 10 to 60 percent by mass and more preferably from 20 to 60 percent by mass to the entire mass of the first processing fluid to quickly dry and reliably discharge the second processing fluid.

### Surfactant

The proportion of the surfactant in the second processing fluid is not particularly limited and it can be suitably selected to suit a particular application. It is preferably from 0.001 to 5 percent by mass and more preferably from 0.05 to 5 percent by mass to achieve good wettability and discharging stability.

The resin and the other optional components in the second processing fluid can be qualitatively and quantitatively analyzed by Gas Chromatography Mass Spectrometry (GC-MS), for example. The measuring device in the GC-MS, the method of determining each functional group in each component in the second processing fluid, the moisture's content in the second processing fluid can be analyzed in the same manner as in those for the first processing fluid.

### Property of Second Processing Fluid

Properties of the second processing fluid are not particularly limited and they can be suitably selected to suit to a particular application. The viscosity, surface tension, and pH of the second processing fluid are preferably the same as those of the first processing fluid.

### White Ink

The white ink in the present specification refers to a liquid composition for forming a white image by applying it to the region of the fabric where the first processing fluid and the second processing fluid have been applied.

A white image formed with the white ink on fabric serves as a backdrop of a color image formed with a color ink to be applied to the region where the white ink has been applied, which enhances the coloring of the color image.

In the present specification, “white” is a color referred to as white appropriately accepted under normal social conventions and includes slightly colored white.

The white ink contains a coloring material and preferably resin and other optional components.

### Coloring Material

The coloring material in the white ink is not particularly limited and can be suitably selected to suit to a particular application. For example, in organic or organic white pigments are preferable.

The inorganic white pigment is not particularly limited and it can be suitably selected to suit to a particular application.

Specific examples include, but are not limited to, sulfates of alkali earth metals such as barium sulfide, carbonates of alkali earth metals such as calcium carbonates, silicas such as fine powder of silicic acid and synthetic silicate, calcium silicate, alumina, hydrated alumina, titanium oxide, zinc oxide, talc, and clay. These can be used alone or in combination.

The organic white pigment is not particularly limited and can be suitably selected to suit to a particular application. These can be used alone or in combination.

Of these, the coloring material in the white ink mentioned above is preferably an inorganic white pigment. Titanium oxide is more preferable in terms of white concealing.

The method of obtaining a white ink by dispersing the white pigment mentioned above is not particularly limited and it can be suitably selected to suit to a particular application.

It includes a method of preparing a self-dispersible pigment through introducing a hydrophilic functional group into the white pigment mentioned above, a method of coating the surface of the pigment with a resin followed by dispersion, or a method of using a dispersant for dispersing the pigment.

One way of preparing a self-dispersible pigment by introducing a hydrophilic functional group into the pigment mentioned above is to add a functional group such as a sulfone group and carboxyl group to a pigment (e.g., carbon) to disperse the pigment in water.

One way of dispersing a pigment by coating the surface of the pigment with resin is to encapsulate pigment particles in microcapsules to disperse in water. This microencapsulated pigment is also referred to as a resin-coated pigment. The resin-coated pigment particles in the white ink mentioned above are not necessarily entirely coated with resin.

Pigment particles not partially or wholly covered with resin may be dispersed in the ink unless such particles have an adverse impact.

As the dispersant for use in the dispersion method described above, a known dispersant of a small or large molecular weight, typically a surfactant, is suitable.

The surfactant is not particularly limited and it can be suitably selected depending on the type of a pigment. For example, anionic surfactants, cationic surfactants, nonionic surfactants, and amphoteric surfactants are usable. These can be used alone or in combination.

Also, a nonionic surfactant, RT-100, manufactured by TAKEMOTO OIL & FAT CO., LTD. and a formalin condensate of naphthalene sodium sulfonate are suitable as the dispersant.

The proportion of the coloring material in the white ink mentioned above is not particularly limited and can be suitably selected to suit to a particular application.

It is preferably from 0.1 to 15 percent by mass and more preferably from 1 to 15 percent by mass to enhance the fixability, and discharging stability.

The method of manufacturing the white ink is not particularly limited and can be suitably selected to suit to a particular application. One way of manufacturing is to mix the other optional components, such as water and an organic solvent. It is also possible to mix the pigment with the other optional components, such as water and a dispersant, to prepare a pigment dispersion followed by mixing the pigment dispersion with materials, such as water and an organic solvent, to manufacture an ink.

The method of preparing the pigment dispersion mentioned above is not particularly limited and can be selected to suit to a particular application. It includes, for example, a method of admixing water, a pigment, and other optional components for dispersion followed by adjusting the particle diameter. Using a dispersing device for dispersion is possible.

The particle diameter of the pigment in the pigment dispersion mentioned above is not particularly limited and it can be suitably selected to suit to a particular application. The maximum frequency is preferably from 20 to 500 nm and more preferably from 20 to 150 nm in the maximum number conversion to improve dispersion stability of the pigment and to ameliorate discharging stability and the image quality such as image density.

The particle diameter of a pigment can be analyzed using a particle size analyzer (Nanotrac Wave-UT151, manufactured by MicrotracBEL Corp).

The proportion of the pigment in the pigment dispersion is not particularly limited and it can be suitably selected to suit a particular application. The proportion of the pigment to the entire mass of the pigment dispersion is preferably from 0.1 to 50 percent by mass and more preferably from 0.1 to 40 percent by mass to stabilize discharging and enhance the image

It is preferable that the pigment dispersion be filtered with an instrument such as filter and a centrifuge to remove coarse particles followed by deaerating.

### Resin

The type of the resin in the white ink mentioned above is not particularly limited and can be suitably selected to suit to a particular application. It includes, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins. These can be used alone or in combination.

The resin particle can be synthesized or procured.

The resin in the white ink mentioned above preferably contains a resin with a carboxyl group (hereinafter also referred to as a carboxyl group-containing resin).

When the white ink contains a carboxyl group-containing resin, the carboxyl group in the carboxyl group-containing resin is allowed to react with the resin in the second processing fluid, preferably the oxazoline group in the oxazoline group-containing Therefore, in addition to an aggregate produced in the cross-linking reaction between the carboxyl group in the organic acid salt in the first processing fluid and the resin in the second processing fluid, another aggregate is produced in the cross-linking reaction between the carboxyl group in the carboxyl group-containing resin in the white ink mentioned above and the resin, preferably the oxazoline group of the oxazoline group-containing resin, in the second processing fluid, making the aggregated film stronger, which enhances fastness of the film.

Resin particles formed of these resins may be used.

It is possible to obtain a white ink by mixing a resin emulsion in which the resin particles are dispersed in water as a dispersion medium with the coloring material mentioned above and the other optional materials, such as an organic solvent.

The volume average particle diameter (mean volume diameter) D50 of the resin particle is not particularly limited and can be suitably selected to suit to a particular application. The mean volume diameter is preferably from 10 to 1,000 nm, more preferably from 10 to 200 nm, and particularly preferably from 10 to 100 nm to achieve good fixability and image hardness.

The volume average particle diameter can be measured by using a device, such as a particle size analyzer (Nanotrac Wave-UT151, manufactured by MicrotracBEL Corp.).

The proportion of the resin to the white ink is not particularly limited and can be suitably selected to suit to a particular application. It is preferably from 1 to 30 percent by mass and more preferably from 5 to 30 percent by mass to the entire ink in terms of fixability and storage stability of the ink.

### Other Optional Components

The other optional components in the white ink are not particularly limited and they can be suitably selected to suit to a particular application. Examples include, but are not limited to, an organic solvent, water, a surfactant, a defoaming agent, a pH regulator, a preservatives and fungicides, and a corrosion inhibitor. These can be used alone or in combination.

Since the other optional components in the white ink can be used in the same manner as those in the first processing fluid, their description is omitted. However, the proportions of the organic solvent and the surfactant mentioned above in the white ink are preferably the same as those in the second processing fluid.

Each component in the white ink can be qualitatively and quantitatively analyzed by a Gas Chromatography Mass Spectrometry (GC-MS), for example. The measuring device in the GC-MS, the method of determining each functional group in each component in the white ink, the amount of moisture in the white ink can be analyzed in the same manner as in those for the first processing fluid.

### Property of White Ink

### Viscosity of White Ink

The viscosity of the white ink at 25 degrees C. is not particularly limited and it can be suitably selected to suit to a particular application. The viscosity is preferably the same as that of the first processing fluid.

### Particle Diameter of Solid Content of White Ink

The particle diameter of the solid content in the white ink mentioned above is not particularly limited and it can be suitably selected to suit to a particular application. For example, the maximum frequency in the maximum number conversion is preferably from 20 to 1,000 nm and more preferably from 20 to 150 nm to ameliorate the discharging stability and image quality such as optical density. The solid content contains the resin particles mentioned above and pigment particles.

The particle diameter of the solid content of the white ink can be measured by using a particle size analyzer (Nanotrac Wave-UT151, manufactured by MicrotracBEL Corp.).

### Storage Elastic Modulus G′ of Dried Matter of White Ink

The storage elastic modulus G′ of dried matter (hereinafter also referred to as white ink dried matter) obtained by drying the white ink mentioned above in measuring dynamic viscoelasticity at 25 degrees C. is not particularly limited and it can be suitably selected to suit to a particular application. It is preferably 7.0×10⁸ Pa or less and more preferably 4.0 x 108 Pa or less to produce an image with excellent fastness due to high flexibility.

The storage elastic modulus G′ at 25 degrees C. of the dried matter obtained by drying the white ink mentioned above can be adjusted by changing the resin's molecular weight or glass transition temperature, the concentration of a tri- or higher monomer in the resin with a cross-linking structure by the monomer, and the concentration of the hydrogen bond producing components, such as a urethane group or urea group.

If the resin in the white ink has a large molecular weight, the storage elastic modulus G′ is likely to increase. If the resin in the white ink has a small molecular weight, the storage elastic modulus G′ is likely to decrease.

If the resin in the white ink has a high glass transition temperature, the storage elastic modulus G′ is likely to increase. If the resin in the white ink has a low glass transition temperature, the storage elastic modulus G′ is likely to decrease.

In addition, if the concentration of a tri- or higher monomer in the resin with a cross-linking structure by the monomer is high, the storage elastic modulus G′ is likely to increase. If the concentration is low, the storage elastic modulus G′ is likely to decrease.

The tri- or higher valent monomer is not particularly limited. It can be suitably selected from the known monomers.

In the present specification, 6 mL of the white ink dried matter is obtained by placing the white ink mentioned above in a Teflon® petri dish with a diameter of 50, drying it at 40 degrees C. and 60 percent RH for 12 hours, drying it at 150 degrees C. and 60 percent RH for 12 hours, and drying it at 150 degrees C. with a reduced pressure of 0.5 mmHg for three hours.

The test piece for use in measuring the dynamic viscoelasticity at 25 degrees C. of dried matter obtained by drying the white ink mentioned above has a film thickness of from 0.2 to 0.5 mm, a length of 20 mm, and a width of from 4.5 to 5.5 mm. The film thickness is adjustable by adjusting the concentration of ink to be dried.

In the present specification, the value of the storage elastic modulus G′ in measuring the dynamic viscoelasticity at 25 degrees C. of dried matter obtained by drying the white ink mentioned above is measured with ARES-G2 with a refrigerator, manufactured by TA Instruments. After the test piece is set in a device at 20 degrees C. using a torsion clamp as a jig for fixing the test piece, the test piece is cooled down to −70 degrees C. under Auto tension of 2 g. Ten minutes after the temperature reaches −70 degrees, the test piece is measured under the following conditions. The storage elastic modulus at 25 degrees C. can be read based on the obtained measuring data.

### Measuring Conditions

Measuring mode: temperature sweep
Measuring range of temperature: −70 to 160 degrees C.
Rate of temperature rising: 4 degrees C./min
Frequency: 1 Hz
Initial distortion: 0.1 percent
Auto tension: 2 g
Printing Medium

The printing medium for the set of liquid compositions is not particularly limited. Plain paper, gloss paper, special paper, and cloth can be used.

The printing medium is not limited to typical printing media and suitably include building materials such as wall paper and floor material, cloth for apparel such as T-shirts, textile, and leather.

Of these, the printing medium for use in printing is preferably fabric in the present disclosure.

The fabric in the present disclosure refers to an item with a form of textile, knitted work, and non-woven fabric manufactured from. The breadth of fiber and the mesh size are not particularly limited.

The fiber is not particularly limited and it can be suitably selected to suit to a particular application. It includes, but is not limited to, natural fiber, recycled fiber, synthetic fiber, semi-synthetic fiber, biodegradable fiber, and mixed fiber thereof.

The natural fiber includes, but is not limited to, fiber formed of cotton, hemp, wool, silk, or mixed fiber thereof.

The recycle fiber includes, but is not limited to, fiber formed of viscose, lyocell, polynosic, rayon, cupra, or mixed fiber thereof.

Specific examples of the synthetic fiber include, but are not limited to, polypropylene, polyester, acetate, triacetate, polyurethane, polyamide, poluimide, acylic, polyvinyl alcohol, polyvinyl chloride, nylon, Nomex® (manufactured by E.I. du Pont de Nemours and Company), Kevlar® (manufactured by E.I. du Pont de Nemours and Company), and mixed fiber thereof.

Specific examples of the semi-synthetic fiber include, but are not limited to, fiber formed of acetate, diaceate, triacetate, or mixed fiber thereof.

One of the biodegradable fiber is fiber formed of polylactic acid.

Of the fibers forming the fabric mentioned above, synthetic fiber of a substance such as polyester is difficult to demonstrate good white concealing property and strike a balance between white concealing property and fastness compared to natural fiber, such as cotton. However, the first processing fluid and the second processing fluid suitably work on such fabrics, striking a balance between the white concealing property and fastness.

The fabric is colored in such a manner that the fiber in the fabric chemical or physically holds a dye inside or at the surface of the fabric. The present disclosure is excellent regarding white concealing even when the fabric is dark-colored.

The dark colored fabric in the present specification has a luminosity as low as L* of 50 or less in the L*a*b* color space.

The L*a*b* color space is regulated by International Commission on Illumination (CIE). In the L*a*b* color space, L refers to lightness, and the chromaticity representing hue and saturation is represented with a*b*. a*b* expresses the color direction, in which a* is red direction, −a* is green direction, b* is yellow direction, and −b* is blue direction.

The dye for use in the fabric is not particularly limited and can be suitably selected to suit to a particular application. It includes, but is not limited to, direct dye, acidic dye, disperse dye, cationic dye, vat dye, sulfide dye, reactive dye, and naphthol dye.

Of these, the disperse dye is likely to migrate during thermal fixing. However, the first processing fluid and the second processing fluid works suitably on fabric containing a disperse dye, demonstrating excellent white concealing and fastness.

The fabric is preferably free of a fluorescent dye.

The usage of the set of liquid compositions of the present disclosure is not particularly limited and can be suitably selected to suit to a particular application. For example, the liquid compositions can be used for printed matter, a paint, a coating material, and foundation. The liquid compositions can be used as ink to produce two-dimensional text and images. They also can be used as a material for solid fabrication for manufacturing a three-dimensional image (or solid freeform fabrication object).

The set of liquid compositions of the present disclosure can be suitably used for various printing devices employing an inkjet printing method, such as printers, facsimile machines, photocopiers, multifunction peripherals (serving as a printer, a facsimile machine, and a photocopier), and solid freeform fabrication devices (e.g., 3D printers and additive manufacturing devices).

Any known device can be used as the device for manufacturing a solid freeform fabrication object without a particular limit. For example, a device including a container, supplying device, discharging device, drier of ink, and others can be used. The solid freeform fabrication object includes an object manufactured by repetitive coating of ink. In addition, the solid freeform fabrication object includes a mold-processed product manufactured by processing a structure having a substrate such as a printing medium to which the ink is applied. The mold-processed product is manufactured from printed matter or a structure having a sheet-like form and film-like form by, for example, heating drawing or punching. The mold-processed product is suitably used to produce items surface-decorated after molding such as gauges or operation panels of vehicles, office machines, electric and electronic devices, and cameras.

### Image Forming Method and Image Forming Apparatus

An image forming method includes applying a first processing fluid containing an organic acid salt to fabric, applying a second processing fluid containing a resin to the region of the fabric where the first processing fluid has been applied, and applying a white ink to the region of the fabric where the second processing fluid has been applied. The method may include other optional processes.

The image forming apparatus of the present disclosure includes a device for applying a first processing fluid containing an organic acid salt to fabric, a device for applying a second processing fluid containing a resin to the region of the fabric where the first processing fluid has been applied, and a device for applying a white ink to the region of the fabric where the second processing fluid has been applied.

Preferably, the apparatus includes a container for containing the first processing fluid, a container for containing the second processing fluid, and a container for containing the white ink. It may furthermore optionally include other devices.

In the present disclosure, the image forming apparatus are capable of discharging the first processing fluid, the second processing fluid, the white ink, and other optional processing fluids to a printing medium. The image forming method forms images using the apparatus. The printing medium refers to an item to which the first processing fluid, the second processing fluid, the white ink, and other optional processing fluids, can attach temporarily or permanently. It is preferably fabric.

In addition, the image forming apparatus and the image forming method are not limited to those for producing meaningful visible images such as text and figures with ink. The method and apparatus include creating patterns like geometric design and 3D images.

The image forming method of the present disclosure is preferably executed with the image forming apparatus of the present disclosure.

The image forming method of the present disclosure is described together with the image forming apparatus of the present disclosure.

### Container for Containing First Processing Fluid

The container for containing the first processing fluid contains the first processing fluid.

The container for containing the first processing fluid can be an ink cartridge, which is described later.

The first processing fluid is the same as that of the set of liquid compositions of the present disclosure. The description of the first processing fluid is thus omitted.

### Applying First Processing Fluid and Device for Applying First Processing Fluid

Applying the first processing fluid is to apply the first processing fluid containing an organic acid salt to fabric.

The device for applying the first processing fluid is to apply the first processing fluid containing an organic acid salt to fabric.

The device for applying the first processing fluid executes applying the first processing fluid.

The method of applying the first processing fluid is not particularly limited and it can be suitably selected to suit to a particular application. It includes inkjetting, spray coating, blade coating, gravure coating, bar coating, roll coating, dip coating, curtain coating, slide coating, and die coating.

Of these, inkjetting is preferable as the method of applying the first processing fluid.

The amount per unit of area of the first processing fluid applied to the fabric mentioned above is not particularly limited and can be suitably selected to suit to a particular application. It is preferably from 10 to 200 mg/cm², more preferably from 15 to 100 mg/cm², and furthermore preferably from 30 to 60 mg/cm² to achieve a high level of white concealing. An amount of the first processing fluid of 10 mg/cm² or greater is preferable to hold the second processing fluid and the ink at the surface of fiber. An amount of the first processing fluid of 200 mg/cm² or less is preferable to quickly dry.

### Container for Containing Second Processing Fluid

The container for containing the second processing fluid contains the second processing fluid.

The container for containing the second processing fluid can be an ink cartridge, which is described later.

The second processing fluid is the same as that of the set of liquid compositions of the present disclosure. The description of the second processing fluid is thus omitted.

### Applying Second Processing Fluid and Device for Applying Second Processing Fluid

Applying the second processing fluid is to apply the second processing fluid containing a resin to fabric.

The device for applying the second processing fluid is to apply the second processing fluid to the region of the fabric where the first processing fluid has been applied.

The device for applying the second processing fluid executes applying the second processing fluid.

In the image forming method, it is necessary to separate applying the first processing fluid from applying the second processing fluid. Applying the first processing fluid and the second processing fluid simultaneously is not suitable to form a resin film in the second processing fluid on the fiber's surface layer.

If the first and the second processing fluids are mixed, the mixture of the processing fluids agglomerates before the mixture is applied. Therefore, applying the first processing fluid is independent from the second processing fluid to enhance the white sealing effect.

Preferably, the second processing fluid is applied to the region of the fabric where the first processing fluid has been applied while the first processing fluid is still wet on the fabric. This application is also referred to as wet-on-wet.

While the first processing fluid is still wet means one of the following 1 to 3 in the present specification.

1. Applying the second processing fluid to fabric while 70 percent by mass or more of the solvent in the first processing fluid remains on the fabric.

2. Applying the second processing fluid to fabric within 120 seconds of the application of the first processing fluid.

3. No forcible drying between applying the first processing fluid and applying the second processing fluid.

Applying the first processing fluid while it is still wet does not include applying the first processing fluid and the second processing fluid simultaneously as described above, i.e., executing the application of the first processing fluid and the second processing fluid simultaneously, or applying a mixture of the first processing fluid and the second processing fluid to fabric.

The carboxyl group in the organic acid salt in the first processing fluid is allowed to conduct cross-linking reaction with the resin in the second processing fluid by applying the second processing fluid to fabric while the first processing fluid is still wet. Note that the first processing fluid does not mix with the second processing fluid and can suitably maintain the film of sticky first processing fluid even when the second processing fluid is applied to the first processing fluid on the fabric while the first processing fluid is still wet.

In the present specification, the forcible drying process refers to artificial blowing wind or heating, not including natural drying at 5 to 35 degrees C. and 5 to 90 percent RH. The first processing fluid can be wet even under conditions other than these temperature and humidity conditions as long as the 1 and 2 mentioned above are satisfied.

Artificial heating is conducted at temperatures other than the natural drying conditions and is higher than 35 degrees C., for example. The heating time is not particularly limited for artificial heating. It can be one minute or longer, for example. The forcible drying includes the same conditions as those of heating and drying, which are described later.

The method of applying the second processing fluid is not particularly limited and can be suitably selected to suit to a particular application. The second processing fluid can be applied in the same manner as in those of the first processing fluid and the device for applying the first processing fluid.

The amount per unit of area of the second processing fluid applied to the fabric mentioned above is not particularly limited and can be suitably selected to suit to a particular application. It is preferably from 0.1 to 50 mg/cm², more preferably from 1 to 30 mg/cm², and furthermore preferably from 2 to 20 mg/cm² to inhibit the white ink from permeating the fabric. An amount of from 0.1 mg/cm² or greater is preferable to enhance white concealing and an amount of 50 mg/cm² or greater is preferable to achieve soft texture.

The amount of the second processing fluid used is not particularly limited and can be suitably selected to suit to a particular application. Preferably, the molar ratio of the resin in the second processing fluid to the organic acid salt in the first processing fluid is preferably at 0.5:1 or less and more preferably 0.25:1 or less. A molar ratio of the resin in the second fluid to the organic acid salt in the first processing fluid of 0.5:1 or less prevents the pigments in the white ink from excessively agglomerating on the fabric when the white ink is applied later. The white ink thus suitably fixes on the fabric. A molar ratio of the resin in the second processing fluid to the organic acid salt in the first processing fluid of 0.01:1 or greater is preferable to fix a white ink image better.

### Container for Containing White Ink

The container for containing the white ink contains the white ink mentioned above. The container for containing the white ink can be an ink cartridge, which is described later.

The white ink is the same as that of the set of liquid compositions of the present disclosure. The description of the white ink is thus omitted.

### White Ink Applying Process and White Ink Applying Device

In the application of the white ink, the white ink containing an organic acid salt is applied to fabric.

The device for applying the white ink applies the white ink containing an organic acid salt to fabric.

The device for applying the white ink suitably executes applying the white ink.

In the image forming method, it is necessary to apply the first processing fluid and the second processing fluid separately. Applying the second processing fluid and the white ink simultaneously or applying a mixture of the second processing fluid and the white ink involves a problem of degrading white concealing. Therefore, applying the second processing fluid and the white ink separately leads to an excellent white sealing effect.

Preferably, the white ink is applied to the region of the fabric where the second processing fluid has been applied while the second processing fluid is still wet. This is also referred to as wet-on-wet.

While the second processing fluid is still wet means one of the following 1 to 3 in the present specification.

1. Applying the white ink to fabric while 70 percent by mass or more of the solvent in the second processing fluid remains on the fabric.

2. Applying the white ink to fabric within 120 seconds of the application of the second processing fluid.

3. No forcible drying between applying the second processing fluid and applying the white ink.

Applying the second processing fluid while it is still wet does not include applying the second processing fluid and the white ink simultaneously as described above, i.e., executing the application of the second processing fluid and the white ink simultaneously, or applying a mixture of the second processing fluid and the white ink to fabric.

The carboxyl group in the resin, preferably the carboxyl group-containing resin, in the white ink is allowed to conduct cross-linking reaction with the resin in the second processing fluid by applying the white ink to fabric while the second processing fluid is still wet. Note that the second processing fluid does not mix with the white ink and can suitably maintain the film of sticky second processing fluid even when the white ink is applied to the second processing fluid on the fabric while the second processing fluid is still wet.

In the present specification, the forcible drying process refers to artificial blowing wind or heating, not including natural drying at 5 to 35 degrees C. and 5 to 90 percent RH. The second processing fluid is wet even in the conditions other than these temperature and humidity conditions as long as the 1 and 2 mentioned above is satisfied.

Artificial heating is conducted at temperatures other than the natural drying conditions and is higher than 35 degrees C., for example. The heating time is not particularly limited for artificial heating. It can be one minute or longer, for example. The forcible drying includes the same conditions as those of heating and drying, which are described later.

When the second processing fluid is applied to the region of the fabric where the first processing fluid has been applied while the first processing fluid is still wet and the white ink is applied to the region of the fabric where the second processing fluid has been applied while the second processing fluid is still wet, the first processing fluid can form a protective layer for inhibiting color transfer from the fabric and then the second processing fluid suitably can form a white ink reception layer.

The method of applying the white ink is not particularly limited and can be suitably selected to suit to a particular application. The white ink can be applied by the same manner as the method of applying the first processing fluid and the device for applying the first processing fluid.

The amount per unit of area of the white ink applied to the fabric mentioned above is not particularly limited and can be suitably selected to suit to a particular application. It is preferably from 5 to 50 mg/cm², more preferably from 10 to 40 mg/cm², and furthermore preferably from 15 to 30 mg/cm² to achieve a high level of white concealing. An amount of from 5 mg/cm² or greater is preferable to enhance white concealing and an amount of 50 mg/cm² or greater is preferable to achieve soft texture.

The amount of the white ink used is not particularly limited and can be suitably selected to suit to a particular application. The amount of the resin, preferably the carboxyl group-containing resin, in the white ink is preferably 5 parts by mass or less and more preferably 3 parts by mass or less to 1 part by mass of the resin in the second processing fluid. A mass ratio (parts by mass) of the resin in the white ink to the resin in the second processing fluid of 5:1 or less prevents the pigments in the white ink from excessively agglomerating on the fabric when the white ink is applied. The white ink thus suitably fixes on the fabric. A mass ratio (percent by mass) of the resin in the white ink to the resin in the second processing fluid of 1:1 or greater is preferable to fix a white ink image better.

### Other Processes and Other Devices

The other processes include, but are not limited to, heating or drying, applying color ink, and applying a post-processing fluid.

The other devices include, but are not limited to, a heating or drying device, a device for applying a color ink, a device for feeding, conveying, and ejecting a printing medium, and a a device for applying a post-processing fluid.

### Heating or Drying and Heating or Drying Device

The heating or drying is to heat or dry the printing surface on which the first processing fluid, the second processing fluid, or the white ink is applied or the opposite surface.

The drying device is to heat or dry the printing surface on which the first processing fluid, the second processing fluid, or the white ink is applied or the opposite surface. The heating or drying device suitably executes heating or drying.

The image forming method preferably includes heating and drying to enhance the fixability of an image on the fabric.

The heating or drying device is not particularly limited and can be selected from available heating or drying devices. It includes a roll heater, a drum heater, an infrared heater, a heated wind generator, and heat pressing device.

The heating temperature is not particularly limited and it can be suitably selected to suit to a particular application. It is preferably 150 degrees C. or higher and more preferably from 150 to 200 degrees C.

The heating time is not particularly limited and it can be suitably selected to suit to a particular application. It is preferably one minute or longer and more preferably from one to about five minutes.

The heating or drying can be executed before, during, or after printing. Drying or heating can be conducted either or both between the application of the first processing fluid and the second processing fluid and between the application of the second processing fluid and the white ink. As described above, since the second processing fluid is preferably applied to fabric while the first processing fluid is still wet and the white ink is applied while the second processing fluid is still wet, it is preferable to apply the first processing fluid, the second processing fluid, and the white ink without a break, followed by heating or drying instead of heating or drying between the application of the first processing fluid and the second processing fluid and between the application of the second processing fluid and the white ink. This process sequence forms a white ink layer on the fabric, enhancing the white concealing property.

### Applying Color Ink and Device for Applying Color Ink

The applying a color ink is to apply a color ink to the white ink after the white ink is applied. If the image forming method includes drying, a color ink is applied to the white ink layer after the drying process mentioned above.

The device for applying a color ink is to apply a color ink to the white ink.

The device for applying a color ink suitably executes applying a color ink.

If the white ink forms an underlayer of a color ink, the color ink is not particularly limited and can be suitably selected among known color inks.

The color ink in the present specification is a liquid composition for forming a color image by applying to the region of fabric where the white ink has been applied.

The color in the present specification refers to the color not included in the white mentioned above. It includes, for example, Y (yellow), M (magenta), C (cyan), and K (black).

The method of applying a color ink is not particularly limited and can be suitably selected to suit to a particular application. The color ink can be applied in the same manner as the method of applying the first processing fluid and the device for applying the first processing fluid.

### Applying Post-processing Fluid and Device for Applying Post-processing Fluid

A post-processing fluid is applied to form a transparent layer after the white ink is applied.

The device for applying a post-processing fluid forms a transparent layer after the white ink is applied.

The device for applying the post-processing fluid suitably executes applying the post-processing fluid.

The post-processing fluid is not particularly limited and can be suitably selected to suit to a particular application. Examples include, but are not limited to, an organic solvent, water, a resin, a surfactant, a defoaming agent, a pH regulator, preservatives and fungicides, and a corrosion inhibitor. These are selected based on a necessity basis and mixed to obtain a post-processing fluid. The post-processing fluid can be applied to the entire printing region formed on a printing medium or only the region on which an ink image is formed.

The method of applying a post-processing fluid is not particularly limited.

Specific examples include, but are not limited to, inkjetting, roller coating, gravure coating, gravure offset coating, bar coating, roll coating, knife coating, air knife coating, comma coating, U comma coating, AKKU coating, smoothing coating, MICROGRAVURE™ coating, reverse roll coating, four or five roll coating, dip coating, curtain coating, slide coating, and die coating.

The image forming method and the image forming apparatus of the present disclosure are specifically described with reference to the drawings but are not limited to those.

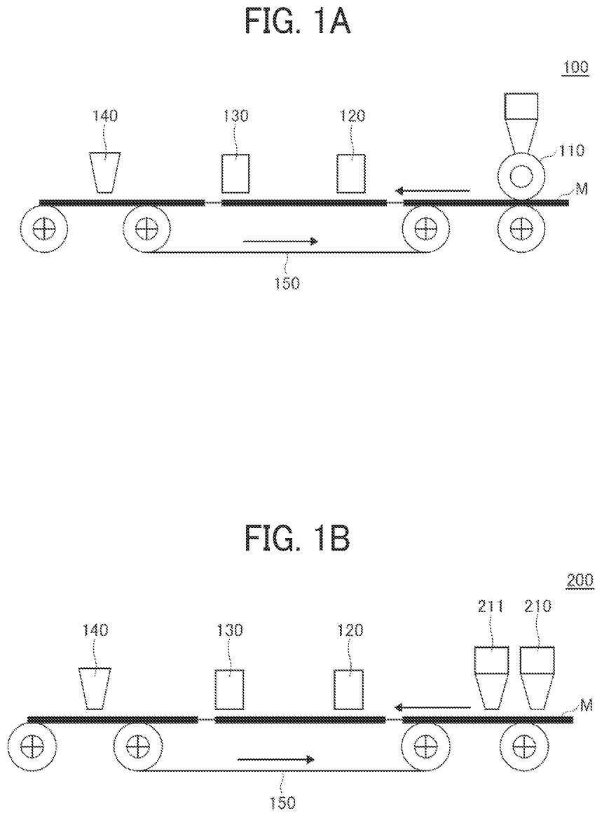

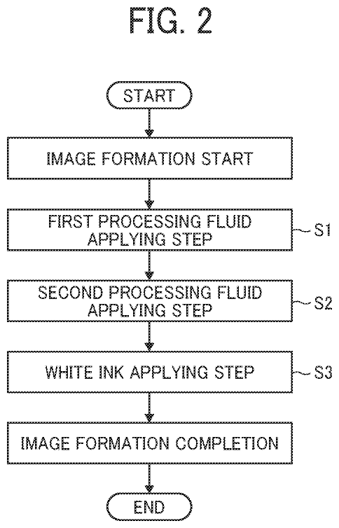

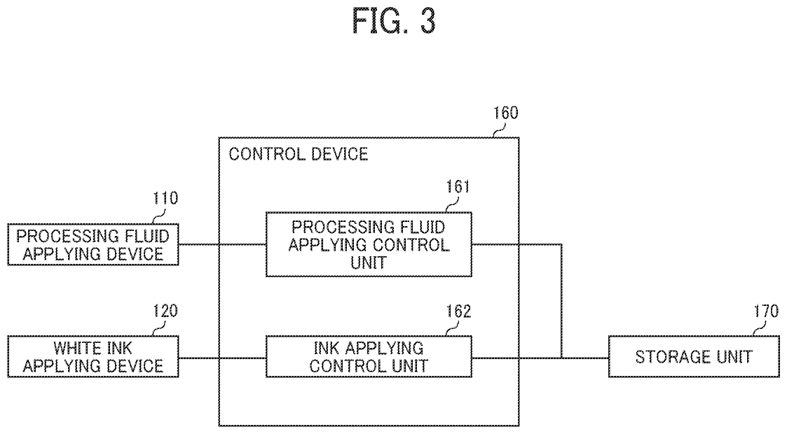

FIG. 1A is a schematic diagram illustrating an example of the image forming apparatus of the present disclosure. FIG. 2 is a schematic diagram illustrating an example of a controlling device of the image forming apparatus illustrated in FIG. 1A. FIG. 3 is a flowchart illustrating an example of the operation of the image forming apparatus illustrated in FIG. 1A.

The white ink, the first processing fluid, and the second processing fluid can be applied with a single image forming apparatus or with separate image forming apparatuses, such as printers.

An image forming apparatus 100 as an example of the image forming apparatus of the present disclosure includes a processing fluid applying device 110, a white ink applying device 120, a control device 160, a storage unit 170, and other optional devices such as a post-processing fluid applying device 130, a drying device 140, and a conveyance device 150. The processing fluid applying device 110 applied the first processing fluid or the second processing fluid to a printing medium M. There is only one processing fluid applying device 110 in FIG. 1A. It independently applies the first or second processing fluid.

The method of applying the first or second processing fluid with the processing fluid applying device 110 is not particularly limited. Any available method can be used. It includes, but is not limited to, the following methods: dipping a printing medium in the first or second processing fluid (dip coating method); applying the first or second processing fluid with a roller coater (roller coating method); spraying the first or the second processing fluid with a spraying device (spray coating method); and spraying the first or second processing fluid by inkjetting (inkjet applying method). Of these, dip coating, roller coating, spray coating, and inkjet coating are preferable to have a simple configuration and quickly apply the first or second processing fluid.

The white ink applying device 120 applies a white ink to the surface of the printing medium M where the first or second processing fluid has been applied.

Any known inkjet head can be used as the white ink applying device 120.

In FIG. A, there is only a white ink applying device 120 as the ink applying device. A head that discharges any color ink other than white ink can be configured in the same manner as that of the white ink applying device 120. The head may discharge ink of color such as Y (yellow), M (magenta), C (cyan), and K (black).

The storage unit 170 is a hard disk drive (HDD) and retains data of image to be printed. An example of the control device 160 of the image forming apparatus 100 is a central processing unit (CPU) and provides instructions to the storage unit 170 and each control unit.

A processing fluid applying control unit 161 controls the driving of the processing fluid applying device 110 in response to the instruction from the control device 160.

An ink applying control unit 162 controls the driving of the white ink applying device 120 in response to the instruction from the control device 160. If the image forming apparatus 100 including an ink applying device for applying an ink other than a white ink, the ink applying control unit 162 controls the driving of such an ink applying device.

The post-processing fluid applying device 130 applies a post-processing fluid to the region of the surface of the printing medium M where the inkjet ink has been applied. The post-processing fluid applying device 130 can be a spray or a roller other than an inkjet head. The post-processing fluid applying device 130 can be omitted.

The image forming apparatus 100 may include the drying device 140 for drying the printing surface onto which the first processing fluid, the second processing fluid, and the white ink have been applied and the opposite surface. Optionally, the printing medium M can be dried after other liquids such as a processing fluid are applied and before and after applying each liquid. As the heating device (heater), many known heating devices can be used.

Specific examples of the drying device 140 include, but are not limited to, devices for heating with heated wind, radiation heating, conduction heating, or microwave drying, a heat press, and a fixing roller. These can be used alone or in combination of two or more thereof. Preferably, the level of drying is determined depending on the heat shrinking property a printing medium relating to the thickness and material thereof. Of these, a heat press is preferable to enhance fastness of liquid film and quickly heat the printing medium M. The drying device 140 can be omitted.

The conveyance device 150 conveys the printing medium M. There is no specific limit to the conveyance device 150 as long as it can convey the printing medium M. A conveyance belt or a platen can be used as the conveyance device 150. The conveyance device 150 can be omitted.

The image forming apparatus 100 may furthermore include a fixing unit for heat-fixing an image formed on the printing medium M. The fixing unit is not particularly limited. A fixing roller can be used as the fixing unit.

An image forming apparatus used as a desktop printer further includes a liquid container containing a first processing fluid, a second processing fluid, and a post-processing fluid and a liquid discharging head as another aspect of the post-processing fluid device in the same manner as for general color ink such as black (K), cyan (C), magenta (M), and yellow (Y) ink and it discharges the first processing fluid, the second processing fluid, and the post-processing fluid by inkjetting.

### Example of Operation of Image Forming Apparatus 100

The behavior of the image forming apparatus 100 is described next. FIG. 3 is a flowchart illustrating an example of the image forming apparatus 100.

On receiving an instruction of starting image forming, the image forming apparatus 100 initiates an image forming operation.

In Step S1, the conveyance device 150 in the image forming apparatus 100 conveys the printing medium M and the processing fluid applying device 110 applies the first processing fluid to the printing medium M. At this point, the processing fluid applying device 110 applies the first processing fluid only to the image forming portion or the entire of the printing medium M.

The processing fluid applying device 110 applies the first processing fluid only to the image forming portion in the printing medium M after the application region is determined in response to the instruction from the processing fluid applying control unit 161 or the control device 160.

The processing fluid applying device 110 applies the first processing fluid to the entire of the printing medium M in response to the instruction from the processing fluid applying control unit 161 or the control device 160.

In Step S2, the processing fluid applying device 110 applies the second processing fluid to the printing medium M fed by the conveyance device 150, where the first processing fluid has been applied. At this point, the processing fluid applying device 110 applies the second processing fluid only to the portion where the first processing fluid has been applied or the entire of the printing medium M. In the present disclosure, the processing fluid applying device 110 preferably applies the second processing fluid to the portion where the first processing fluid has been applied.

The second processing fluid is applied only to the image forming portion in the printing medium M after the application region is determined in response to the instruction from the processing fluid applying control unit 161 or the control device 160.

The processing fluid applying device 110 applies the second processing fluid to the entire of the printing medium M in response to the instruction from the processing fluid applying control unit 161 or the control device 160.

In Step S3, the white ink applying device 120 discharges a white ink to the printing medium M fed by the conveyance device 150, where the first processing fluid and the second processing fluid have been applied. At this point, the white ink applying device 120 applies the white ink to the portion where the first processing fluid and the second processing fluid have been applied or the entire of the printing medium M. In the present disclosure, the white ink applying device 120 preferably applies the white ink to the portion where the first processing fluid and the second processing fluid have been applied.

The white ink applying device 120 discharges a white ink only to the image forming portion in the printing medium M after the application region is determined in response to the instruction from the ink applying control unit 162 or the control device 160.

The white ink applying device 120 discharges a white ink to the entire of the printing medium M in response to the instruction from the ink applying control unit 162 or the control device 160.

The image forming apparatus 100 may optionally include a sensor for recognizing the position and place of the printing medium M. Due to the sensor that recognizes the position and the place of the printing medium M, the processing fluid applying device 110 and the white ink applying device 120 can more efficiently apply the first processing fluid, the second processing fluid, and the white ink to the printing medium M in Step S1, Step S2, and Step S3.

After Step S3, the conveyance device 150 may convey the printing medium M where the first processing fluid, the second processing fluid, and the white ink have been applied to the drying device 140, where the printing medium M is dried. The drying device 140 is not indispensable to the image forming method or the image forming apparatus in the present disclosure.

If dispensing with this drying, a user may manually dry the printing medium M using another drier. In the present disclosure, it is preferable to dispense with the drying.

During this drying process, the drying time and temperature can be constant or adjusted depending on the amount of the first processing fluid, the second processing fluid, and the white ink applied. It is preferable to adjust the amount of the first processing fluid, the second processing fluid, and the white ink applied.

The image forming apparatus 100 may optionally include a sensor for recognizing the amount of the first processing fluid, the second processing fluid, and the white ink applied to the printing medium M applied to the printing medium M. Due to this sensor, the drying time and temperature are determined and adjusted in accordance with the amount of the first processing fluid, the second processing fluid, and the white ink applied to the printing medium M. The drying device 140 can thus dry the printing medium M more efficiently.

The sensor may recognize the amount of the first processing fluid, the second processing fluid, and the white ink applied to the printing medium M based on the amount of liquid actually attached to the printing medium M. Alternatively, it can recognize the amount discharged from each applying device to the printing medium M by measuring.

The image forming apparatus 100 completes the image forming operation by drying the printing medium M. It may optionally include taking out the printing medium M from the image forming apparatus 100 and conveying the printing medium M.

FIG. 1B is a schematic diagram illustrating another example of the image forming apparatus of the present disclosure.

An image forming apparatus 200 as another example of the image forming apparatus of the present disclosure includes a first processing fluid applying device 210 and the second processing fluid applying device 211 instead of the processing fluid applying device 110 in the image forming apparatus 100 illustrated in FIG. 1A. The other configurations are the same as those of the image forming apparatus 100 illustrated in FIG. 1A. Their detailed descriptions are thus omitted.

While the image forming apparatus 100 illustrated in FIG. 1A independently applies the first or second processing fluid, the image forming apparatus 200 illustrated in FIG. 1B continuously apply the first processing fluid with the first processing fluid applying device 210 and the second processing fluid with the second processing fluid applying device 211.

Terms such as image forming, recording, printing, and print used in the present disclosure refer to the same meaning. The image forming apparatus of the present disclosure includes both a serial type device in which the discharging head moves and a line type device in which the discharging head is not moved, unless otherwise specified.

Furthermore, in addition to the desktop type, this image forming apparatus includes a device capable of printing images on a wide printing medium having, for example, A0 size and a continuous printer capable of using continuous paper rolled up in a roll-like form as a printing medium.

### Ink Cartridge

The ink cartridge of the present disclosure includes a container and contains the set of liquid compositions of the present disclosure, preferably a container containing the set. It optionally includes other optional members.

An ink cartridge has the advantage that there is no need to touch ink during operations, such as ink change, which frees a user from concerns about dirt on fingers and clothes and prevents ink contamination with foreign objects, such as dust.

The ink cartridge may integrally or separately contain the set of liquid compositions of the first processing fluid, the second processing fluid, and the white ink.

The set of liquid compositions may furthermore optionally contain a color ink. If the color ink contains one or more types of color inks, the ink cartridge may integrally or separately contain the first processing fluid, the second processing fluid, the white ink, and the one or more types of color inks.

There is no specific limitation to the container. Any form, structure, size, and material can be suitably selected to suit to a particular application. For example, the container includes a plastic container or an ink bag made of a substance, such as aluminum laminate film and resin film.

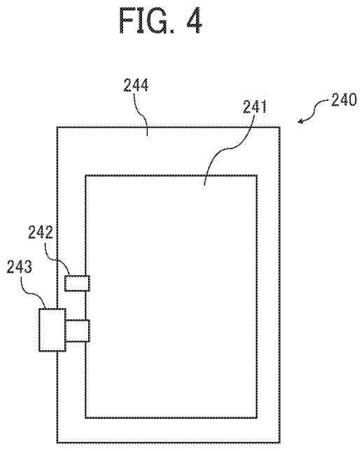

FIG. 4 is a diagram illustrating an example of the ink cartridge that contains the white ink mentioned above. The ink cartridge of the present disclosure is not limited to this example.

An ink bag 241 is filled with the white ink through an ink inlet 242. After the ink bag 241 is deaerated, the ink inlet 242 is closed by fusion. When used, an ink outlet 243 made of rubber is pierced with the needle installed onto an image forming apparatus to supply the ink into the image forming apparatus. The ink bag 241 is made of packaging material with no air permeability, such as aluminum laminate film. A cartridge housing 244, typically made of plastic, accommodates the ink bag 241 and it is detachably attached as an ink cartridge 240 to an image forming apparatus.

The ink cartridge 240 may contain the first or second processing fluid instead of the white ink. It can be used as an ink cartridge for the first or second processing fluid and detachably attachable to an image forming apparatuses as an ink cartridge.

### Printed Matter

The printed matter with an image formed with the image forming method, the image forming apparatus, or the set of liquid compositions of the present disclosure has an image formed with the first processing fluid, the second processing fluid, and the white ink on fabric. This type of printed matter is within the present disclosure.

The printed matter is preferably obtained by printing with an inkjet printing device or inkjet printing method.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Preparation Examples, Examples, and Comparative Examples but is not limited thereto. In Preparation Examples, Examples, and Comparative Examples, parts means parts by mass and proportion for each material means proportion of solid content unless otherwise specified. Preparation and evaluation were conducted at room temperature, 25 degrees C., and 60 percent RH unless otherwise specified.

### Preparation Examples 1-1 to 1-10: Preparation of First Processing Fluids 1 to 10

The flocculants, preservatives, and highly pure water were mixed according to the prescriptions (compositions and proportions) shown in Tables 1-1 and 1-2 followed by one-hour stirring. The mixtures obtained were filtered with a 1.2 μm cellulose acetate membrane filter under pressure to obtain the first processing fluids 1 to 10.

“Parts” in Tables 1-1 and 1-2 represents parts by mass and the total was 100 parts by mass. The flocculant's proportion is represented in salt concentration.

TABLE 1-1

| | | First processing fluid | | | | |
|---|---|---|---|---|---|---|
| | | Preparation | Preparation | Preparation | Preparation | Preparation |
| | | Example | Example | Example | Example | Example |
| | | 1-1 | 1-2 | 1-3 | 1-4 | 1-5 |
| | | First | First | First | First | First |
| | | processing | processing | processing | processing | processing |
| Prescription (parts by mass) | | fluid 1 | fluid 2 | fluid 3 | fluid 4 | fluid 5 |
| Flocculant in | Calcium | 3 | 6 | 10 | — | — |
| salt | lactate | | | | | |
| concentration | Calcium | — | — | — | 3 | 6 |
| | acetate | | | | | |
| | monohydrate | | | | | |
| | Ammonium | — | — | — | — | — |
| | lactate | | | | | |
| | Aluminum | — | — | — | — | — |
| | lactate | | | | | |
| | Calcium | — | — | — | — | — |
| | chloride | | | | | |
| | dihydrate | | | | | |
| | Calcium | — | — | — | — | — |
| | nitrate | | | | | |
| | tetrahydrate | | | | | |
| Preservative | PROXEL LV | 0.1 | 0.1 | 0.1 | 0.1 | 0.1 |
| Water | Highly pure | Balance | Balance | Balance | Balance | Balance |
| | water | | | | | |

TABLE 1-2

| | | First processing fluid | | | | |
|---|---|---|---|---|---|---|
| | | Preparation | Preparation | Preparation | Preparation | Preparation |
| | | Example | Example | Example | Example | Example |
| | | 1-6 | 1-7 | 1-8 | 1-9 | 1-10 |
| | | First | First | First | First | First |
| | | processing | processing | processing | processing | processing |
| Prescription (parts by mass) | | fluid 6 | fluid 7 | fluid 8 | fluid 9 | fluid 10 |
| Flocculant in | Calcium lactate | — | — | — | — | — |
| salt | Calcium acetate | 10 | — | — | — | — |
| concentration | monohydrate | | | | | |
| | Ammonium lactate | — | 10 | — | — | — |
| | Aluminum lactate | — | — | 5 | — | — |
| | Calcium chloride | — | — | — | 6 | — |
| | dihydrate | | | | | |
| | Calcium nitrate | — | — | — | — | 6 |
| | tetrahydrate | | | | | |
| Preservative | PROXEL LV | 0.1 | 0.1 | 0.1 | 0.1 | 0.1 |
| Water | Highly pure water | Balance | Balance | Balance | Balance | Balance |

### Preparation Examples 2-1 to 2-9: Preparation of Second Processing Fluids 1 to 9

The solvents, surfactants, defoaming agents, flocculants, preservatives, resins, and highly pure water were mixed according to the prescriptions (compositions and proportions) shown in Tables 2-1 and 2-2 followed by one-hour stirring. The mixtures obtained were filtered with a 1.2 μm cellulose acetate membrane filter under pressure to obtain the second processing fluids 1 to 9.

“Parts” in Tables 2-1 and 2-2 represents parts by mass and the total was 100 parts by mass. The proportion of resin represents the proportion of solid content.

TABLE 2-1

| | | Second processing fluid | | | | |
|---|---|---|---|---|---|---|
| | | Preparation | Preparation | Preparation | Preparation | Preparation |
| | | Example | Example | Example | Example | Example |
| | | 2-1 | 2-2 | 2-3 | 2-4 | 2-5 |
| | | Second | Second | Second | Second | Second |
| | | processing | processing | processing | processing | processing |
| Prescription (parts by mass) | | fluid 1 | fluid 2 | fluid 3 | fluid 4 | fluid 5 |
| Solvent | Glycerin | 20.0 | 20.0 | 20.0 | 20.0 | 20.0 |
| | Solfit ® (3- | 10.0 | 10.0 | 10.0 | 10.0 | 10.0 |
| | methoxy-3- | | | | | |
| | methyl-1-butanol) | | | | | |
| Surfactant | BYK-348 | 0.2 | 0.2 | 0.2 | 0.2 | 0.2 |
| | (silicone-based | | | | | |
| | surfactant) | | | | | |
| Defoaming | Surfynol ® AD01 | 0.2 | 0.2 | 0.2 | 0.2 | 0.2 |
| agent | | | | | | |
| Preservative | PROXEL LV | 0.1 | 0.1 | 0.1 | 0.1 | 0.1 |
| Resin (solid | EPOCROS ® K- | 0.5 | 1.0 | 5.0 | 10.0 | — |
| content) | 2010E (polymer | | | | | |
| | having an | | | | | |
| | oxazoline group, | | | | | |
| | Tg of −50 degrees | | | | | |
| | C.) | | | | | |
| | EPOCROS ® K- | — | — | — | — | 5.0 |
| | 2020E (polymer | | | | | |
| | having an | | | | | |
| | oxazoline group, | | | | | |
| | Tg of 0 degrees | | | | | |
| | C.) | | | | | |
| | EPOCROS ® K- | — | — | — | — | — |
| | 2035E (polymer | | | | | |
| | having an | | | | | |
| | oxazoline group, | | | | | |
| | Tg of 50 degrees | | | | | |
| | C.) | | | | | |
| | SUPERFLEX SF- | — | — | — | — | — |
| | 460 (urethane | | | | | |
| | resin, Tg of −21 | | | | | |
| | degrees C.) | | | | | |
| | 7320 (acrylic | — | — | — | — | — |
| | resin, Tg of −20 | | | | | |
| | degrees C.) | | | | | |
| | SUMIKAFLEX ®, | — | — | — | — | — |
| | S-400HQ | | | | | |
| | (ethylene vinyl | | | | | |
| | acetate resin, Tg | | | | | |
| | of 0 degrees C.) | | | | | |
| Water | Highly pure water | Balance | Balance | Balance | Balance | Balance |

TABLE 2-2

| | | Second processing fluid | | | |
|---|---|---|---|---|---|
| | | Preparation | Preparation | Preparation | Preparation |
| | | Examples | Examples | Examples | Examples |
| | | 2-6 | 2-7 | 2-8 | 2-9 |
| | | Second | Second | Second | Second |
| | | processing | processing | processing | processing |
| Prescription (parts by mass) | | fluid 6 | fluid 7 | fluid 8 | fluid 9 |
| Solvent | Glycerin | 20.0 | 20.0 | 20.0 | 20.0 |
| | Solfit ® (3-methoxy- | 10.0 | 10.0 | 10.0 | 10.0 |
| | 3-methyl-1-butanol) | | | | |
| Surfactant | BYK-348 (silicone- | 0.2 | 0.2 | 0.2 | 0.2 |
| | based surfactant) | | | | |
| Defoaming agent | Surfynol ® AD01 | 0.2 | 0.2 | 0.2 | 0.2 |
| Preservative | PROXEL LV | 0.1 | 0.1 | 0.1 | 0.1 |
| Resin (solid | EPOCROS ® K- | — | — | — | — |
| content) | 2010E (polymer | | | | |
| | having an oxazoline | | | | |
| | group, Tg of -50 | | | | |
| | degrees C.) | | | | |
| | EPOCROS ® K- | — | — | — | — |
| | 2020E (polymer | | | | |
| | having an oxazoline | | | | |
| | group, Tg of 0 | | | | |
| | degrees C.) | | | | |
| | EPOCROS ® K- | 5.0 | — | — | — |
| | 2035E (polymer | | | | |
| | having an oxazoline | | | | |
| | group, Tg of 50 | | | | |
| | degrees C.) | | | | |
| | SUPERFLEX SF- | — | 5.0 | — | — |
| | 460 (urethane resin, | | | | |
| | Tg of −21 degrees C.) | | | | |
| | 7320 (acrylic resin, | — | — | 5.0 | — |
| | Tg of −20 degrees C.) | | | | |
| | SUMIKAFLEX ®, | — | — | — | 5.0 |
| | S-400HQ (ethylene | | | | |
| | vinyl acetate resin, | | | | |
| | Tg of 0 degrees C.) | | | | |
| Water | Highly pure water | Balance | Balance | Balance | Balance |

### Preparation Example 3-1: Preparation of White Ink 1

### Preparation of Liquid Dispersion of White Pigment

A total of 40 parts of titanium oxide (JR-405, manufactured by TAYCA CORPORATION), 5 parts of a pigment dispersant (TEGO® Dispers 651, manufactured by Evonik Japan Co., Ltd.), and 55 parts of water were mixed followed by dispersion at 8 m/s for five minutes using a bead mill (Research Labo, manufactured by Shinmaru Enterprises Corporation) with zirconia beads having 0.3 mm diameter with a filling ratio of 60 percent by volume to obtain a liquid dispersion of white pigment.

The volume average particle diameter D50 of the liquid dispersion of the white pigment was measured with a nanoparticle size measuring device, Nanotrac Wave-EX1500, manufactured by MicrotracBEL Corp. It was 210 nm.

### Synthesis of Liquid Dispersion 1 of Resin Particle

A liquid dispersion 1 of resin particles was synthesized in the following manner.

In a four-necked flask equipped with a stirrer, a reflux condenser, a thermometer, and a nitrogen blowing tube, 150 g of polycarbonate polyol (Duranol T5651, manufactured by Asahi Kasei Chemicals Corporation) with a number average molecular weight Mn of 1,000, 20.0 g of dimethylol propionic acid, 120 g of dicyclohexylmethane diisocyanate (HINDI), and 270 g of acetone were allowed to react at 75 degrees C. for four hours to obtain an acetone solution of urethane prepolymer. This solution was cooled down to 40 degrees C. and neutralized with 15 g of triethylamine. Thereafter, 900 g of water was gradually added to complete emulsification dispersion using a homogenizer. Thereafter, an aqueous solution in which 15 g of 2-methyl-1,5-pentane diamine was dissolved in 100 g of water was added followed by stirring for one hour. The resulting substance was purged of the solvent at 50 degrees C. with a reduced pressure to obtain about 30 percent by mass of non-volatile portion, thereby obtaining a liquid dispersion 1 of resin particles.

The volume average particle diameter D50 of the liquid dispersion 1 of the resin was measured with a nanoparticle size measuring device, Nanotrac Wave-EX1500, manufactured by MicrotracBEL Corp. It was 60 nm.

### Preparation of White Ink

The white ink 1 of the prescription (composition and proportion) shown in Table 3 was obtained.

After the materials of the prescription other than the liquid dispersion of white pigment and the liquid dispersion 1 of resin particle were dissolved in deionized water to prepare a vehicle, the vehicle was mixed with the liquid dispersion 1 of resin particle. The mixture obtained was mixed with the liquid dispersion of white pigment followed by filtering with a filter with an average pore size of 5 μm to obtain a white ink 1.

Parts in Table 3 represents parts by mass and the total is 100 parts by mass.

### Preparation Example 3-2: Preparation of White Ink 2

A white ink 2 was prepared in the same manner as in the preparation of the white ink 1 of Preparation Example 3-1 except that the liquid dispersion 1 of resin particle was changed to the liquid dispersion 2 of resin particles, which was synthesized in the following manner.

### Synthesis of Liquid Dispersion 2 of Resin Particle

A liquid dispersion 2 of resin particles was synthesized in the following manner.

In a four-necked flask equipped with a stirrer, a reflux condenser, a thermometer, and a nitrogen blowing tube, 150 g of polycarbonate polyol (Duranol T5650E, manufactured by Asahi Kasei Chemicals Corporation) with a number average molecular weight Mn of 500, 20.0 g of dimethylol propionic acid, 120 g of dicyclohexylmethane diisocyanate (HINDI), and 270 g of acetone were allowed to react at 75 degrees C. for four hours to obtain an acetone solution of urethane prepolymer. This solution was cooled down to 40 degrees C. and neutralized with 15 g of triethylamine. Thereafter, 900 g of water was gradually added to complete emulsification dispersion using a homogenizer. Thereafter, an aqueous solution in which 15 g of 2-methyl-1,5-pentane diamine was dissolved in 100 g of water was added followed by stirring for one hour. The resulting substance was purged of the solvent at 50 degrees C. with a reduced pressure to achieve about 30 percent by mass of non-volatile portion, thereby obtaining a liquid dispersion 2 of resin particles.

The volume average particle diameter D50 of the liquid dispersion 2 of the resin was measured with a nanoparticle size measuring device, Nanotrac Wave-EX1500, manufactured by MicrotracBEL Corp. It was 60 nm.

### Preparation Example 3-3: Preparation of White Ink 3

A white ink 3 was prepared in the same manner as in the preparation of the white ink 1 of Preparation Example 3-1 except that the liquid dispersion 1 of resin particle was changed to the liquid dispersion 3 of resin particles, which was synthesized in the following manner.

### Synthesis of Liquid Dispersion 3 of Resin Particle

A liquid dispersion 3 of resin particles was synthesized in the following manner.

In a four-necked flask equipped with a stirrer, a reflux condenser, a thermometer, and a nitrogen blowing tube, 150 g of polycarbonate polyol (Duranol T5650J, manufactured by Asahi Kasei Chemicals Corporation) with a number average molecular weight Mn of 800, 20.0 g of dimethylol propionic acid, 120 g of dicyclohexylmethane diisocyanate (HINDI), and 270 g of acetone were allowed to react at 75 degrees C. for four hours to obtain an acetone solution of urethane prepolymer. This solution was cooled down to 40 degrees C. and neutralized with 15 g of triethylamine. Thereafter, 900 g of water was gradually added to complete emulsification dispersion using a homogenizer. Thereafter, an aqueous solution in which 15 g of 2-methyl-1,5-pentane diamine was dissolved in 100 g of water was added followed by stirring for one hour. The resulting substance was purged of the solvent at 50 degrees C. with a reduced pressure to achieve about 30 percent by mass of non-volatile portion, thereby obtaining a liquid dispersion 3 of resin particles.

The volume average particle diameter D50 of the liquid dispersion 3 of the resin was measured with a nanoparticle size measuring device, Nanotrac Wave-EX1500, manufactured by MicrotracBEL Corp. It was 60 nm.

### Preparation Example 3-4: Preparation of White Ink 4

A white ink 4 was prepared in the same manner as in the preparation of the white ink 1 of Preparation Example 3-1 except that the liquid dispersion 1 of resin particle was changed to the liquid dispersion 4 of resin particles, which was synthesized in the following manner.

### Synthesis of Liquid Dispersion 4 of Resin Particle

A liquid dispersion 4 of resin particles was synthesized in the following manner. In a four-necked flask equipped with a stirrer, a reflux condenser, a thermometer, and a nitrogen blowing tube, 150 g of polyether polyol (PTMG1000, manufactured by Mitsubishi Chemical Corporation) with a number average molecular weight Mn of 1,000, 20.0 g dimethylol propionic acid, 120 g of dicyclohexylmethane diisocyanate (HINDI), and 270 g of acetone were allowed to react at 75 degrees C. for four hours to obtain an acetone solution of urethane prepolymer. This solution was cooled down to 40 degrees C. and neutralized with 15 g of triethylamine. Thereafter, 900 g of water was gradually added to complete emulsification dispersion using a homogenizer. Thereafter, an aqueous solution in which 15 g of 2-methyl-1,5-pentane diamine was dissolved in 100 g of water was added followed by stirring for one hour. The resulting substance was purged of the solvent at 50 degrees C. with a reduced pressure to achieve about 30 percent by mass of non-volatile portion, thereby obtaining a liquid dispersion 4 of resin particles.

The volume average particle diameter D50 of the liquid dispersion 4 of the resin was measured with a nanoparticle size measuring device, Nanotrac Wave-EX1500, manufactured by MicrotracBEL Corp. It was 70 nm.

### Measuring of Storage Elastic Modulus G′

The storage elastic modulus G′ of the white inks 1 to 4 obtained was measured by dynamic viscoelasticity measuring.

First, 6 mL of each of the white inks 1 to 4 was placed in a Teflon® petri dish with a diameter of 50, dried at 40 degrees C. and 60 percent RH for 12 hours, then dried at 150 degrees C. and 60 percent RH for 12 hours, and dried at 150 degrees C. under a reduced pressure of 0.5 mmHg for three hours to obtain dried film of each white ink. The dynamic viscoelasticity of the dried film of each white ink obtained was measured at 25 degrees C. with ARES -G2 with a refrigerator, manufactured by TA Instruments. After the test piece was set in a device at 20 degrees C. using a torsion clamp as a jig for fixing the test piece, the test piece was cooled down to −70 degrees C. under Auto tension of 2 g. Ten minutes after the temperature reached −70 degrees, the test piece was measured under the following conditions. The storage elastic modulus G′ at 25 degrees C. was read based on the obtained measuring data. The results are shown in Table 3.

### Measuring Conditions

Measuring mode: temperature sweep
Measuring range of temperature: −70 to 160 degrees C.
Rate of temperature rising: 4 degrees C./min
Frequency: 1 Hz
Initial distortion: 0.1 percent
Auto tension: 2 g

TABLE 3

| | | White ink | | | |
|---|---|---|---|---|---|
| | | Preparation | Preparation | Preparation | Preparation |
| | | Examples | Examples | Examples | Examples |
| | | 3-1 | 3-2 | 3-3 | 3-4 |
| | | White | White | White | White |
| Prescription (parts by mass) | | ink 1 | ink 2 | ink 3 | ink 4 |
| Solvent | Glycerin | 20.0 | 20.0 | 20.0 | 20.0 |
| | Solfit ® (3- | 10.0 | 10.0 | 10.0 | 10.0 |
| | methoxy-3- | | | | |
| | methyl-1-butanol) | | | | |
| Surfactant | BYK-348 | 0.2 | 0.2 | 0.2 | 0.2 |
| | (silicone-based | | | | |
| | surfactant) | | | | |
| Defoaming agent | Surfynol ® AD01 | 0.2 | 0.2 | 0.2 | 0.2 |
| Preservative | PROXEL LV | 0.1 | 0.1 | 0.1 | 0.1 |
| Pigment | Liquid dispersion | 25.0 | 25.0 | 25.0 | 25.0 |
| (solid content) | of white pigment | | | | |
| Resin (solid | Liquid dispersion | 30.0 | — | — | — |
| content) | 1 of resin particle | | | | |
| | (volume average | | | | |
| | particle diameter | | | | |
| | D50 of 60 nm) | | | | |
| | Liquid dispersion | — | 30.0 | — | — |
| | 2 of resin particle | | | | |
| | (volume average | | | | |
| | particle diameter | | | | |
| | D50 of 60 nm) | | | | |
| | Liquid dispersion | — | — | 30.0 | — |
| | 3 of resin particle | | | | |
| | (volume average | | | | |
| | particle diameter | | | | |
| | D50 of 60 nm) | | | | |
| | Liquid dispersion | — | — | — | 30.0 |
| | 4 of resin particle | | | | |
| | (volume average | | | | |
| | particle diameter | | | | |
| | D50 of 60 nm) | | | | |
| Water | Deionized water | Balance | Balance | Balance | Balance |

| | | | | |
|---|---|---|---|---|
| Storage elastic modulus | 1.2 × 10⁸ | 6.9 × 10⁸ | 3.8 × 10⁸ | 7.7 × 10⁷ |
| G′ (Pa) at 25 degrees C. | | | | |

The following was used as each material shown in Tables 1-1, 1-2, 2-1, 2-2, and 3.
SOLFIT®: 3-methoxy-3-methyl-1-butanol (manufactured by KURARAY CO., LTD.)
BYK-348: silicone-based surfactant (manufactured by BYK-Chemie GmbH)
Surfynol® AD01: Organic gemini type surfactant (defoaming agent, manufactured by Air Products and Chemicals, Inc.)
Proxel LV: 1,2-benzothiazoline-3-one (preservative, effective component of 20 percent by mass, manufactured by LONZA Japan)
EPOCROS° K-2010E: polymer with an oxazoline group (polymer main chain: styrene/acrylic Tc of −50 degrees C., manufactured by NIPPON SHOKUBAI CO., LTD.)
EPOCROS° K-2020E: polymer with an oxazoline group (polymer main chain: styrene/acrylic Tc of 0 degrees C., manufactured by NIPPON SHOKUBAI CO., LTD.)
EPOCROS° K-2035E: polymer with an oxazoline group (polymer main chain: styrene/acrylic Tc of 50 degrees C., manufactured by NIPPON SHOKUBAI CO., LTD.)
SUPERFLEX® 460: urethane resin, Tg of −21 degrees C., manufactured by DKS Co., Ltd.
7320: acrylic resin, Tg of −20 degrees C., manufactured by Japan Coating Resin Co., Ltd.
SUMIKAFLEX®, S-400HQ, ethylene vinyl acetate resin, Tg of 0 degrees C., manufactured by Sumitomo Chemical Company

### Examples 1 to 19 and Comparative Examples 1 to 3

### Preparation of Liquid Composition

The first processing fluids 1 to 10 obtained in Preparation Examples 1-1 to 1-10, the second processing fluids 1 to 9 obtained in Preparation Examples 2-1 to 2-9, the white inks 1 to 4 obtained in Preparation Examples 3-1 to 3-4 were combined as shown in Table 4 below to prepare the sets 1 to 22 of liquid compositions of Examples 1 to 19 and Comparative Examples 1 to 3.

### Printing Method

The sets 1 to 22 of liquid compositions prepared were used for printing in the following manner.

### Applying First Processing Fluid

A black polyester T-shirt (manufactured by TOMS CO., LTD.) cut to A4 size was placed on the platen of an inkjet printer (RICOH Ri 2000, manufactured by Ricoh Co., Ltd.), followed by spray-applying one of the first processing fluids 1 to 10 in an amount of 50 mg/cm^{2.}

### Applying Second Processing Fluid

One minute after the first processing fluid was applied, one of the second processing fluids 1 to 9 placed in the inkjet printer (RICOH Ri 2000, manufactured by Ricoh Co., Ltd.) mentioned above was inkjetted in an amount of 20 mg/cm² in a superposed manner to the region of the T-shirt where the first processing fluid was applied while the first processing fluid was still wet.

### Applying White Ink

One minute after the second processing fluid was applied, one of the white inks 1 to 4 placed in the inkjet printer (RICOH Ri 2000, manufactured by Ricoh Co., Ltd.) mentioned above was inkjetted in an amount of 20 mg/cm² in a superposed manner to the region of the T-shirt where the first and second processing fluids were applied while the second processing fluid was still wet, forming a solid image.

### Drying

The solid image was dried at 140 degrees C. for one minute with a heat press.

### Example 20

Using the set 2 of liquid composition prepared in Example 2, printing was conducted in the same manner as in those of Examples 1 to 19 and Comparative Examples 1 to 3 except that the printing method was changed from those of Examples 1 to 19 and Comparative Examples 1 to 3 to the following.

### Printing Method

The printing was conducted in the same manner as that in Examples 1 to 19 and Comparative Examples 1 to 3 except that, using the set 2 of liquid compositions, the first processing fluid was dried in the following manner after the first processing fluid was applied, and the second processing fluid was applied in the following manner.

### Drying First Processing Fluid

A T-shirt to which the first processing fluid 2 was applied was dried at 120 degrees C. for one minute with a heat press.

### Applying Second Processing Fluid

Then the second processing fluid 3 placed in the inkjet printer (RICOH Ri 2000, manufactured by Ricoh Co., Ltd.) mentioned above was inkjetted in an amount of 20 mg/cm² in a superposed manner to the region of the T-shirt where the first processing fluid 2 was applied and dried.

The dried solid images of Examples 1 to 20 and Comparative Examples 1 to 3 were evaluated regarding white concealing and color fastness to washing and laundering in the following manner.

The combinations of the first processing fluid, the second processing fluid, and the white ink and the evaluation results on white concealing property and color fastness to washing and laundering are shown in Table 4.

### Evaluation on White Concealing Property

The black polyester T-shirt, manufactured by TOMS CO., LTD., was measured on the optical density OD with a spectrophotometer, X-Rite eXact, manufactured by Videojet X-Rite K.K. before printing. This OD was determined as original fabric OD.

Next, the white solid images of Examples 1 to 20 and Comparative Examples 1 to 3 were measured on the optical density OD with a spectrophotometer, X-Rite eXact, manufactured by Videojet X-Rite K.K. This OD was determined as solid image OD.

The white concealing was calculated based on the following relationship 1 from these OD values and evaluated according to the following evaluation criteria. Levels S, A, and B are allowable for a practical purpose in the following evaluation criteria.

White concealing (percent)=(original fabric OD−solid image OD)/(original fabric OD)×100 (percent) Relationship 1

### Evaluation Criteria

S: White concealing was 93 percent or greater
A: White concealing was from 88 to less than 93 percent
B: White concealing was from 85 to less than 88 percent
C: White concealing was less than 85 percent

### Evaluation on Color Fastness to Washing and Laundering

The T-shirts of Examples 1 to 20 and Comparative Examples 1 to 3 were tested regarding color fastness to washing and laundering according to the AATCC 61-2A and evaluated according to the following evaluation criteria. Levels S, A, and B are allowable for a practical purpose in the following evaluation criteria.

### Evaluation Criteria

S: Level 4.5 or higher
A: Level 4.0
B: Level 3.5
C: Level 3.0 or lower

TABLE 4

| | | First processing fluid | | | | |
|---|---|---|---|---|---|---|
| | | | Organic | Drying of | | |
| | | | acid salt or | first | | |
| | Set of liquid | | comparative | processing | | |
| | compositions | Type | component | fluid | | |
| Example 1 | 1 | First | Calcium | None | | |
| | | processing | lactate | | | |
| | | fluid 1 | | | | |
| Example 2 | 2 | First | Calcium | None | | |
| | | processing | lactate | | | |
| | | fluid 2 | | | | |
| Example 3 | 3 | First | Calcium | None | | |
| | | processing | lactate | | | |
| | | fluid 3 | | | | |
| Example 4 | 4 | First | Calcium | None | | |
| | | processing | acetate | | | |
| | | fluid 4 | | | | |
| Example 5 | 5 | First | Calcium | None | | |
| | | processing | acetate | | | |
| | | fluid 5 | | | | |
| Example 6 | 6 | First | Calcium | None | | |
| | | processing | acetate | | | |
| | | fluid 6 | | | | |
| Example 7 | 7 | First | Ammonium | None | | |
| | | processing | lactate | | | |
| | | fluid 7 | | | | |
| Example 8 | 8 | First | Ammonium | None | | |
| | | processing | lactate | | | |
| | | fluid 8 | | | | |
| Example 9 | 9 | First | Calcium | None | | |
| | | processing | lactate | | | |
| | | fluid 2 | | | | |
| Example 10 | 10 | First | Calcium | None | | |
| | | processing | lactate | | | |
| | | fluid 2 | | | | |
| Example 11 | 11 | First | Calcium | None | | |
| | | processing | lactate | | | |
| | | fluid 2 | | | | |
| Example 12 | 12 | First | Calcium | None | | |
| | | processing | lactate | | | |
| | | fluid 2 | | | | |
| Example 13 | 13 | First | Calcium | None | | |
| | | processing | lactate | | | |
| | | fluid 2 | | | | |
| Example 14 | 14 | First | Calcium | None | | |
| | | processing | lactate | | | |
| | | fluid 2 | | | | |
| Example 15 | 1. | First | Calcium | None | | |
| | | processing | lactate | | | |
| | | fluid 2 | | | | |
| Example 16 | 16 | First | Calcium | None | | |
| | | processing | lactate | | | |
| | | fluid 2 | | | | |
| Example 17 | 17 | First | Calcium | None | | |
| | | processing | lactate | | | |
| | | fluid 2 | | | | |
| Example 18 | 18 | First | Calcium | None | | |
| | | processing | lactate | | | |
| | | fluid 2 | | | | |
| Example 19 | 19 | First | Calcium | None | | |
| | | processing | lactate | | | |
| | | fluid 2 | | | | |
| Example 20 | 2 | First | Calcium | Yes | | |
| | | processing | lactate | | | |
| | | fluid 2 | | | | |
| Comparative | 20 | First | Calcium | None | | |
| Example 1 | | processing | nitrate | | | |
| | | fluid 9 | | | | |
| Comparative | 21 | First | Calcium | None | | |
| Example 2 | | processing | chloride | | | |
| | | fluid 10 | | | | |
| Comparative | 22 | First | Calcium | None | | |
| Example 3 | | processing | lactate | | | |
| | | fluid 2 | | | | |
| | | | | | Evaluation result | |
| | | | | | | Color |
| | | Second | Drying of | | | fastness to |
| | | processing | second | | White | washing |
| | Set of liquid | fluid | processing | White ink | concealing | and |
| | compositions | Type | fluid | Type | property | laundering |
| Example 1 | 1 | Second | None | White ink | A | S |
| | | processing | | 1 | | |
| | | fluid 3 | | | | |
| Example 2 | 2 | Second | None | White ink | S | S |
| | | processing | | 1 | | |
| | | fluid 3 | | | | |
| Example 3 | 3 | Second | None | White ink | S | S |
| | | processing | | 1 | | |
| | | fluid 3 | | | | |
| Example 4 | 4 | Second | None | White ink | A | S |
| | | processing | | 1 | | |
| | | fluid 3 | | | | |
| Example 5 | 5 | Second | None | White ink | S | S |
| | | processing | | 1 | | |
| | | fluid 3 | | | | |
| Example 6 | 6 | Second | None | White ink | S | S |
| | | processing | | 1 | | |
| | | fluid 3 | | | | |
| Example 7 | 7 | Second | None | White ink | B | S |
| | | processing | | 1 | | |
| | | fluid 3 | | | | |
| Example 8 | 8 | Second | None | White ink | S | A |
| | | processing | | 1 | | |
| | | fluid 3 | | | | |
| Example 9 | 9 | Second | None | White ink | B | S |
| | | processing | | 1 | | |
| | | fluid 1 | | | | |
| Example 10 | 10 | Second | None | White ink | A | S |
| | | processing | | 1 | | |
| | | fluid 2 | | | | |
| Example 11 | 11 | Second | None | White ink | S | S |
| | | processing | | 1 | | |
| | | fluid 4 | | | | |
| Example 12 | 12 | Second | None | White ink | S | A |
| | | processing | | 1 | | |
| | | fluid 5 | | | | |
| Example 13 | 13 | Second | None | White ink | S | B |
| | | processing | | 1 | | |
| | | fluid 6 | | | | |
| Example 14 | 14 | Second | None | White ink | A | B |
| | | processing | | 1 | | |
| | | fluid 7 | | | | |
| Example 15 | 15 | Second | None | White ink | A | B |
| | | processing | | 1 | | |
| | | fluid 8 | | | | |
| Example 16 | 16 | Second | None | White ink | A | B |
| | | processing | | 1 | | |
| | | fluid 9 | | | | |
| Example 17 | 17 | Second | None | White ink | S | A |
| | | processing | | 2 | | |
| | | fluid 3 | | | | |
| Example 18 | 18 | Second | None | White ink | S | A |
| | | processing | | 3 | | |
| | | fluid 3 | | | | |
| Example 19 | 19 | Second | None | White ink | S | S |
| | | processing | | 4 | | |
| | | fluid 3 | | | | |
| Example 20 | 2 | Second | None | White ink | A | S |
| | | processing | | 1 | | |
| | | fluid 3 | | | | |
| Comparative | 20 | Second | None | White ink | S | C |
| Example 1 | | processing | | 1 | | |
| | | fluid 2 | | | | |
| Comparative | 21 | Second | None | White ink | S | C |
| Example 2 | | processing | | 1 | | |
| | | fluid 2 | | | | |
| Comparative | 22 | None | None | White ink | C | B |
| Example 3 | | | | 1 | | |

As seen in the results shown in Table 4, Examples 1 to 20 demonstrated the practical level or above regarding white concealing and color fastness to washing and laundering. However, Comparative Examples 1 to 3 failed to strike a balance between white concealing and color fastness to washing and laundering.

Aspects of the present disclosure include, but are not limited to the following:

1. A set of liquid compositions contains a white ink, a first processing fluid containing an organic acid salt, and a second processing fluid containing a resin, wherein the first processing fluid is applied to fabric before the second processing fluid is applied thereto, and the second processing fluid is applied to the fabric before the white ink is applied thereto.

2. The set according to the 1 mentioned above, wherein the organic acid salt contains at least one of calcium acetate or calcium lactate.

3. The set according to the 1 or 2, wherein the resin has an oxazoline group.

4. The set according to any one of the 1 to 3 mentioned above, wherein the proportion of the resin in the entire of the second processing fluid is from 3 to 10 percent by mass.

5. The set according to the 4 mentioned above, wherein the proportion of the organic acid salt in the entire of the first processing fluid is from 6 to 10 percent by mass.

6. The set according to any one of the 1 or 5 mentioned above, wherein the glass transition temperature of the resin is lower than 0 degrees C.

7. The set according to any one of the 1 to 6 mentioned above, wherein the white ink contains a resin having a carboxyl group.

8. The set according to any one of the 1 to 7, wherein dried matter of the white ink has a storage elastic modulus G′ of 7.0×10⁸ Pa or less in dynamic viscoelasticity measuring at 25 degrees C.

9. An image forming method includes applying a first processing fluid containing an organic acid salt to fabric, applying a second processing fluid containing a resin to the region of the fabric where the first processing fluid has been applied, and applying a white ink to the region of the fabric where the second processing fluid has been applied.

10. The image forming method according to the 9 mentioned above, wherein the set of any one of the 1 to 8 mentioned above is used.

11. The image forming method according to the 9 or 10 mentioned above, wherein applying a second processing fluid includes applying the second processing fluid to the region of the fabric where the first processing fluid has been applied before the first processing fluid dries, and applying a white ink includes applying the white ink to the region of the fabric where the second processing fluid has been applied before the second processing fluid dries.

12. An image forming apparatus includes a device for applying a first processing fluid containing an organic acid salt to fabric, a device for applying a second processing fluid containing a resin to the region of the fabric where the first processing fluid has been applied, and a device for applying a white ink to the region of the fabric where the second processing fluid has been applied.

13. An ink cartridge contains the set of liquid compositions of any one of the 1 to 8 mentioned above.

14. Printed matter includes a substrate and an image formed on the substrate by using one of the set of liquid compositions of any one of the 1 to 8 mentioned above, the image forming method of any one of the 9 to 11 mentioned above, the image forming apparatus of the 12 mentioned above, and the ink cartridge of the 13 mentioned above.

1. A set of liquid compositions comprising:
a white ink;
a first processing fluid comprising an organic acid salt; and
a second processing fluid comprising a resin,
wherein the first processing fluid is applied to fabric before the second processing fluid is applied thereto, and
the second processing fluid is applied to the fabric before the white ink is applied thereto.

2. The set according to claim 1, wherein the of organic acid salt comprises at least one of calcium acetate or calcium lactate.

3. The set according to claim 1, wherein the resin has an oxazoline group.

4. The set according to claim 1, wherein a proportion of the resin in an entire of the second processing fluid is from 3 to 10 percent by mass.

5. The set according to claim 4, wherein a proportion of the organic acid salt in an entire of the first processing fluid is from 6 to 10 percent by mass.

6. The set according to claim 1, wherein the resin has a glass transition temperature Tg below 0 degrees C.

7. The set according to claim 1, wherein the white ink comprises a resin having a carboxyl group.

8. The set according to claim 1, wherein dried matter of the white ink has a storage elastic modulus G′ of 7.0×10⁸ Pa or less in dynamic viscoelasticity measuring at 25 degrees C.

9. An image forming method comprising:
applying a first processing fluid comprising an organic acid salt to fabric;
applying a second processing fluid comprising a resin to a region of the fabric where the first processing fluid has been applied; and
applying a white ink to a region of the fabric where the second processing fluid has been applied.

10. The image forming method according to claim 9, wherein the white ink, the first processing fluid, and the second processing fluid forms a set.

11. The image forming method according to claim 9,
wherein applying a second processing fluid includes applying the second processing fluid to the region of the fabric where the first processing fluid has been applied before the first processing fluid dries, and
applying a white ink includes applying the white ink to the region of the fabric where the second processing fluid has been applied before the second processing fluid dries. to fabric;

12. An image forming apparatus comprising:
a device configured to apply a first processing fluid comprising an organic acid salt to fabric;
a device configured to apply a second processing fluid comprising a resin to a region of the fabric where the first processing fluid has been applied; and
a device configured to apply a white ink to a region of the fabric where the second processing fluid has been applied.
